(19) United States
(12) Patent Application Publication
(10) Pub. No.: US 2024/0177044 A1
(43) Pub. Date: May 30, 2024

(54) MANAGING PROCESSING OF STATES OF SEQUENCES OF DATA

(71) Applicant: ColdQuanta, Inc., Boulder, CO (US)

(72) Inventors: Pranav Gokhale, Chicago, IL (US); Eric Anschuetz, Oviedo, FL (US); Frederic Tsyh-An Chong, Chicago, IL (US)

(73) Assignee: ColdQuanta, Inc., Boulder, CO (US)

(21) Appl. No.: 18/520,952

(22) Filed: Nov. 28, 2023

Related U.S. Application Data
(60) Provisional application No. 63/533,787, filed on Aug. 21, 2023.
(60) Provisional application No. 63/430,455, filed on Dec. 6, 2022.
(60) Provisional application No. 63/430,459, filed on Dec. 6, 2022.
(60) Provisional application No. 63/428,706, filed on Nov. 29, 2022.

(51) Int. Cl. G06N 10/40; G06N 10/20

(52) U.S. Cl. CPC G06N 10/40; G06N 10/20

(57) ABSTRACT

A system comprises a first computing device (CD) comprising processors in communication with a first plurality of quantum storage elements (QSEs); a second CD comprising processors in communication with a non-volatile memory, a second plurality of QSEs, and control circuitry configured to apply quantum gate operations to the second plurality of the QSEs, where the second CD is configured to: read a sequence of data (SOD) from the non-volatile memory, and use the control circuitry to generate quantum states stored in the second plurality of QSEs based at least in part on at least one of (1) a hypergraph-based representation associated with the SOD or (2) random circuit sampling and the SOD, where the SOD provides randomness for the random circuit sampling; and a quantum communication channel between the first CD and the second CD configured to transmit the quantum states from the second CD to the first CD.

### CROSS-REFERENCE TO RELATED APPLICATION(S)

This application claims priority to and the benefit of U.S. Provisional Application Ser. No. 63/533,787, entitled “MANAGING PROCESSING OF STATES OF SEQUENCES OF DATA,” filed Aug. 21, 2023; U.S. Provisional Application Ser. No. 63/430,459, entitled “MANAGING PROCESSING OF STATES OF SEQUENCES OF DATA,” filed Dec. 6, 2022; U.S. Provisional Application Serial No. 63/430,455, entitled “MANAGING PROCESSING OF STATES OF SEQUENCES OF DATA,” filed Dec. 6, 2022; and U.S. Provisional Application Serial No. 63/428,706, entitled “MANAGING PROCESSING OF STATES OF SEQUENCES OF DATA,” filed Nov. 29, 2022; each of which is incorporated herein by reference.

### STATEMENT AS TO FEDERALLY SPONSORED RESEARCH

This invention was made with government support under Grant No. DE-SC0021526 awarded by the US Department of Energy. The government has certain rights in the invention.

### TECHNICAL FIELD

This disclosure relates to managing processing of states of sequences of data.

### BACKGROUND

There are various kinds of physical systems that can allow for quantum computation, including trapped ions, superconducting circuits, neutral atoms, NV-centers, and photonics. Trapped ion quantum computing can utilize electromagnetic fields to trap charged atomic particles-ions. Neutral atom quantum computing can utilize an array of laser light to trap cold atoms. In both trapped ions and neutral atoms, the atomic levels of the ions or atoms can be used as the qubits for quantum computation. Once ions or atoms are confined, their two or more atomic levels can be coupled via laser light, thus allowing one to perform a set of quantum operations. For trapped ions, the motion of the ions may be altered by laser light, and through the Coulomb force, one may quantum mechanically entangle two or more ions. For neutral atoms, a Rydberg blockade may allow for quantum mechanical entanglement across two or more atoms. Some physical systems may allow for the representation of quantum states based on more than two basis states, which can be referred to as quantum digits, also called “qudits.” The techniques described herein with respect to quantum states expressed in qubits can also be implemented using quantum states expressed in qudits.

Both trapped ion and neutral atom quantum computing platforms can store the ions or atoms in a vacuum chamber, thus preventing collisions with background atmospheric gases that would lead to heating. Superconducting circuits, on the other hand, may be stored in a cryogenic environment, such as a dilution refrigerator.

Quantum computers are expected to provide exponential speedups relative to classical techniques for applications such as cryptanalysis and molecular simulation. One example of a classical technique is classical fingerprinting, which has been used to perform efficient algorithms for processing sequences of data.

### SUMMARY

In one aspect, in general, a method for compressing a sequence of data comprising a first number of bits comprises: receiving the sequence of data; generating a hypergraph-based representation based at least in part on the sequence of data, where the generating comprises at least one of: assigning a value for each array element in an adjacency array representation based on at least one bit in the sequence of data, or forming a hypergraph representation where each hyperedge between two or more nodes corresponds to at least one bit in the sequence of data; and generating compressed data associated with the sequence of data based at least in part on the hypergraph-based representation, where the compressed data comprises a second number of qubits less than the first number of bits.

Aspects can include one or more of the following features.

The adjacency array representation contains array elements indicating whether two or more nodes are adjacent or not in the hypergraph representation.

The generating of the compressed data comprises preparing one or more quantum states based at least in part on the hypergraph-based representation.

The method further comprises: using the compressed data as a fingerprint of the sequence of data.

The at least one bit in the sequence of data is exactly one bit.

At least one of the hyperedges connects three or more nodes in the hypergraph representation.

The hypergraph representation is a graph representation and all of the hyperedges are edges that each connect two nodes.

The hypergraph representation is a graph representation and the adjacency array representation is a two-dimensional adjacency matrix.

A first hyperedge connects a first number of nodes and a second hyperedge connects a second number of nodes different from the first number of nodes.

In another aspect, in general, a method for processing states of a sequence of data comprises: receiving a first state of the sequence of data; generating a first hypergraph-based representation based at least in part on the first state of the sequence of data; performing a first instance of an operation on the first state of the sequence of data based at least in part on the first hypergraph-based representation; modifying the first hypergraph-based representation to generate a second hypergraph-based representation, where the modifying comprises: receiving an update comprising a portion of a second state of the sequence of data that differs from the first state of the sequence of data, where the update is less than the entire second state of the sequence of data, and determining a set of hyperedges between nodes in a hypergraph corresponding to the second hypergraph-based representation based on corresponding bits in the update; and performing a second instance of the operation on the second state of the sequence of data based at least in part on the second hypergraph-based representation.

Aspects can include one or more of the following features.

The received update comprises two or more updates.

The received update comprises at least one flipped bit.

The determining of the set of hyperedges occurs after receiving two or more updates.

The operation is a controlled-Z quantum gate operation.

In another aspect, in general, a method for preparing one or more quantum states associated with a sequence of data comprises: generating a hypergraph-based representation based at least in part on the sequence of data; determining a quantum circuit specification specifying a plurality of quantum gate operations, where the determining is based at least in part on the hypergraph-based representation; and applying, from a control module, coupling and transformation operations to a plurality of quantum states associated with respective quantum processing elements of a quantum processor based at least in part on the quantum circuit specification.

Aspects can include one or more of the following features.

The applying of the coupling and transformation operations comprises initializing quantum states associated with respective quantum processing elements stored in the quantum processing elements such that each quantum processing element is in a superposition; and applying controlled-Z quantum gate operations based at least in part on the hypergraph-based representation.

The plurality of quantum gate operations comprises Clifford quantum gate operations.

The quantum circuit specification is a Clifford circuit.

In another aspect, in general, a method for comparing two or more sequences of data comprising a first sequence of data and a second sequence of data comprises: generating a hypergraph-based representation based at least in part on the first sequence of data; determining a first quantum circuit specification specifying a plurality of quantum gate operations, where the determining is based at least in part on the hypergraph-based representation; applying, from a first control module, coupling and transformation operations to one or more input quantum states associated with respective quantum processing elements of a first quantum processor, based at least in part on the first quantum circuit specification, to prepare one or more output quantum states; transmitting the one or more output quantum states to a first set of quantum states associated with respective quantum processing elements of a second quantum processor; receiving, at respective quantum processing elements of the second quantum processor, a second set of quantum states associated with the second sequence of data; and applying, from a second control module, coupling and transformation operations to one or more quantum states associated with respective quantum processing elements of the second quantum processor to compare a first pair of quantum states comprising a first quantum state from the first set of quantum states and a second quantum state from the second set of quantum states.

Aspects can include one or more of the following features.

Generating the hypergraph-based representation comprises assigning a value for each array element in an adjacency array representation based on at least one bit in the first sequence of data.

The adjacency array representation contains array elements indicating whether two or more nodes are adjacent or not in the hypergraph-based representation.

The generating of the hypergraph-based representation comprises forming a hypergraph representation where each hyperedge between two or more nodes corresponds to at least one bit in the first sequence of data.

In another aspect, in general, a system for generating and transmitting quantum states comprises: a first computing device comprising one or more processors in communication with a first plurality of quantum storage elements; a second computing device comprising one or more processors in communication with (1) a non-volatile memory, (2) a second plurality of quantum storage elements, and (3) control circuitry configured to apply quantum gate operations to the second plurality of the quantum storage elements, where the second computing device is configured to: read a first sequence of data from the non-volatile memory, and use the control circuitry to generate a first set of quantum states stored in the second plurality of quantum storage elements based at least in part on at least one of (1) a hypergraph-based representation associated with the first sequence of data or (2) random circuit sampling and the first sequence of data, where the first sequence of data provides randomness for the random circuit sampling; and a quantum communication channel between the first computing device and the second computing device configured to transmit the first set of quantum states from the second computing device to the first computing device.

Aspects can include one or more of the following features.

The first computing device is configured to: receive the first set of quantum states transmitted from the second computing device by the quantum communication channel, and perform one or more measurements on (1) the first set of quantum states and (2) a second set of quantum states generated based at least in part on at least one of (A) a hypergraph-based representation associated with a second sequence of data or (B) random circuit sampling and the second sequence of data, where the second sequence of data provides randomness for the random circuit sampling.

The first sequence of data is associated with at least one of (1) hardware included in the second computing device at a first time or (2) software loaded onto the second computing device at the first time.

The second sequence of data is associated with at least one of (1) hardware included in the second computing device at a second time or (2) software loaded onto the second computing device at a second time different from the first time.

The first computing device is configured to determine if the first sequence of data and the second sequence of data are identical based at least in part on the outcomes of the one or more measurements.

The first computing device is configured to transmit information associated with the outcomes of the one or more measurements to the second computing device.

The second computing device determines if the first sequence of data and the second sequence of data are identical based at least in part on the outcomes of one or more measurements received by the first computing device.

The first sequence of data comprises information associated with a first set of parameters associated with the second computing device.

The second computing device is further configured to: read a third sequence of data from the non-volatile memory, where the third sequence of data comprises information associated with the first set of parameters and a second set of parameters associated with the second computing device, and use the control circuitry to generate a third set of quantum states stored in the second plurality of quantum storage elements based at least in part on at least one of (1) a hypergraph-based representation associated with the third sequence of data or (2) random circuit sampling and the third sequence of data, where the third sequence of data provides randomness for the random circuit sampling.

The first computing device is further configured to determine if the third sequence of data and a fourth sequence of data are identical based at least in part on the outcomes of one or more measurements.

The using of the control circuitry to generate the first set of quantum states stored in the second plurality of quantum storage elements is based at least in part on the hypergraph-based representation associated with the first sequence of data and further comprises at least one of (1) assigning a value for each array element in an adjacency array representation based on at least one bit in the first sequence of data or (2) forming a hypergraph representation where each hyperedge between two or more nodes corresponds to at least one bit in the first sequence of data.

The using of the control circuitry comprises assigning a value for each array element in the adjacency array representation based on at least one bit in the first sequence of data, and each array element indicates whether two or more nodes are adjacent or not in the hypergraph representation.

The using of the control circuitry to generate the first set of quantum states stored in the second plurality of quantum storage elements is based at least in part on the hypergraph-based representation associated with the first sequence of data and further comprises applying controlled-Z quantum gate operations.

The first sequence of data is associated with a configuration of the second computing device.

The system further comprises: a third computing device comprising one or more processors in communication with (1) a second non-volatile memory, (2) a third plurality of quantum storage elements, and (3) control circuitry configured to apply quantum gate operations to the third plurality of the quantum storage elements.

The third computing device is configured to: read a fifth sequence of data from the second non-volatile memory; and use the control circuitry to generate a fifth set of quantum states stored in the third plurality of quantum storage elements.

The using of the control circuitry is based at least in part on at least one of (1) a hypergraph-based representation associated with the fifth sequence of data or (2) random circuit sampling and the fifth sequence of data, where the fifth sequence of data provides randomness for the random circuit sampling.

The system further comprises: a second quantum communication channel between the first computing device and the third computing device configured to transmit quantum states from the third computing device to the first computing device.

In another aspect, in general, a method for comparing two or more sequences of data comprising a first sequence of data and a second sequence of data comprises: determining a first quantum circuit specification specifying a plurality of quantum gate operations, where the determining is based at least in part on the first sequence of data; applying, from a first control module, coupling and transformation operations to one or more quantum states associated with respective quantum processing elements of a first quantum processor, based at least in part on the first quantum circuit specification, to prepare one or more quantum states; transmitting a plurality of copies of the one or more prepared quantum states to a first set of quantum states associated with respective quantum processing elements of a second quantum processor; receiving, at respective quantum processing elements of the second quantum processor, a second set of quantum states associated with the second sequence of data; and applying, from a second control module, coupling and transformation operations to a plurality of quantum states associated with respective quantum processing elements of the second quantum processor to compare a set of quantum state pairs, each quantum state pair comprising a quantum state in the first set of quantum states and a second quantum state in the second set of quantum states, where the comparing comprises performing a collective quantum state measurement over different respective copies of the one or more prepared quantum states.

Aspects can include one or more of the following features.

The determining of the first quantum circuit specification is further based at least in part on random circuit sampling and the first sequence of data, and the first sequence of data provides randomness for the random circuit sampling.

The determining of the first quantum circuit specification is further based at least in part on at least one of (1) an adjacency array corresponding to one or more sequences of data or (2) a hypergraph corresponding to one or more sequences of data.

The method further comprises: applying, from a third control module, coupling and transformation operations to one or more quantum states associated with respective quantum processing elements of a third quantum processor, based at least in part on a second quantum circuit specification, to prepare the second set of quantum states.

The second quantum circuit specification is determined based at least in part on at least one of (1) random circuit sampling and one or more sequences of data, where the one or more sequences of data provides randomness for the random circuit sampling, (2) an adjacency array corresponding to one or more sequences of data, or (3) a hypergraph corresponding to one or more sequences of data.

The method further comprises: transmitting the second set of quantum states from a third quantum processor to the second quantum processor.

In another aspect, in general, a method for compressing a sequence of data comprising a first number of bits comprises: receiving the sequence of data; determining a quantum circuit specification specifying a plurality of quantum gate operations, where the determining is based at least in part on random circuit sampling and the sequence of data, and the sequence of data provides randomness for the random circuit sampling; generating compressed data associated with the sequence of data based at least in part on the quantum circuit specification, where the compressed data comprises a second number of qubits less than the first number of bits.

Aspects can include one or more of the following features.

The generating of the compressed data comprises preparing one or more quantum states based at least in part on the quantum circuit specification.

The method further comprises: using the compressed data as a fingerprint of the sequence of data.

The randomness provided by the sequence of data is seeded randomness.

In another aspect, in general, a method for preparing one or more quantum states associated with a sequence of data comprises: determining a quantum circuit specification specifying a plurality of quantum gate operations, where the determining is based at least in part on random circuit sampling and the sequence of data, and the sequence of data provides randomness for the random circuit sampling; and applying, from a control module, coupling and transformation operations to a plurality of input quantum states associated with respective quantum processing elements of a quantum processor, based at least in part on the quantum circuit specification, to prepare one or more output quantum states associated with the sequence of data.

Aspects can include one or more of the following features.

The randomness provided by the sequence of data is seeded randomness.

The one or more quantum states are used as a fingerprint that identifies the sequence of data.

The one or more quantum states uniquely identify the original data.

The quantum gate operations are selected based at least in part on a unitary t-design.

The quantum gate operations are selected from a probability distribution either over pure quantum states or over unitary operators.

In another aspect, in general, a method for comparing two or more sequences of data comprising a first sequence of data and a second sequence of data comprises: determining a first quantum circuit specification specifying a plurality of quantum gate operations, based at least in part on random circuit sampling and the first sequence of data, where the first sequence of data provides randomness for the random circuit sampling; applying, from a first control module, coupling and transformation operations to one or more input quantum states associated with respective quantum processing elements of a first quantum processor, based at least in part on the first quantum circuit specification, to prepare one or more output quantum states; transmitting the one or more output quantum states to a first set of quantum states associated with respective quantum processing elements of a second quantum processor; receiving, at respective quantum processing elements of the second quantum processor, a second set of quantum states associated with the second sequence of data; and applying, from a second control module, coupling and transformation operations to one or more quantum states associated with respective quantum processing elements of the second quantum processor, based on a second quantum circuit specification, to compare a first pair of quantum states comprising a first quantum state from the first set of quantum states and a second quantum state from the second set of quantum states.

Aspects can include one or more of the following features.

The method further comprises: receiving, at a first digital computer, information based at least in part on measurements associated with the comparing.

The method further comprises: transmitting the information received at the first digital computer to a second digital computer.

The method further comprises: determining the outcome of the comparing based on the information received at the first digital computer.

The method further comprises: transmitting the outcome of the comparing to the second digital computer.

The plurality of quantum gate operations comprises randomly determined unitary operations applied to two or more quantum processing elements.

The second quantum circuit specification includes at least one of a controlled-SWAP test, a destructive swap test, or a test based at least in part on the Hong-Ou-Mandel effect.

The transmitting of the one or more quantum states further comprises transducing the one or more quantum states into photons.

The transmitting of the one or more quantum states comprises performing quantum teleportation.

The transmitting of the one or more quantum states comprises generating a copy of the one or more quantum states, and the one or more quantum states used to generate the copy are destroyed in the copying process.

Two or more of the prepared quantum states are approximately identical and correspond to an identical sequence of data.

Two or more of the prepared quantum states are different and correspond to different sequences of data.

The method further comprises: comparing a second pair of quantum states comprising a third quantum state from the first set of quantum states and a fourth quantum state from the second set of quantum states.

The third quantum state in the first set of quantum states is approximately identical to the first quantum state from the first set of quantum states, and the fourth quantum state from the second set of quantum states is approximately identical to the second quantum state in the second set of quantum states.

The comparing the first pair of quantum states and comparing the second pair of quantum states is performed by a collective measurement.

The second quantum processor is located in a satellite.

The method further comprises: determining an inner product of the first pair of quantum states based on measurements of the first pair.

Each of the quantum processing elements of at least one of the first control module or the second control module are coupled only to one or more of their nearest neighbors.

Comparing the first pair of quantum states comprises performing one or more quantum swap operations between respective pairs of nearest neighbor quantum processing elements; and performing respective measurements on at least every swapped quantum processing element.

Aspects can have one or more of the following advantages.

The subject matter disclosed herein may be deployed in distributed data settings (e.g., accompanying replicas of important databases). QCP-EE can utilize random circuit sampling, thereby endowing quantum supremacy and quantum volume experiments with a plausible application that can be run on near-term hardware and that has previously remained elusive. QCP-IE can perform incremental, constant-time updates for incremental file changes. For example, if a bit is flipped in an N-bit source file, the O(\sqrt{N}) qubit fingerprint can be updated in constant time, a property that no known classical fingerprinting protocols achieve without cryptographic assumptions.

The subject matter disclosed herein provides the ability to verify a large number of bits of information efficiently for security purposes. For example, a hardware provable unclonable function (PUF) provides a unique identifier for silicon chips or quantum hardware in a possibly small number of bits. The file-to-graph and file-to-hypergraph algorithms disclosed herein may be used to verify not only hardware, but also software and any configuration data that is important for the secure operation of an entire computing system. The computing system could be either entirely classical, or hybrid quantum and classical. For example, the algorithms could verify bits associated with the hardware (e.g., a PUF or a secret identifying bitstring), in addition to binary for the software components and any configuration data that is important.

Other features and advantages will become apparent from the following description, and from the figures and claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A is a schematic diagram of an example hybrid quantum-classical computing system.

FIG. 1B is a schematic diagram of an example networked quantum computing system comprising two hybrid quantum-classical computing systems with quantum and classical communication channels.

FIG. 1C is a schematic diagram of an example networked quantum computing system comprising three hybrid quantum-classical computing systems with quantum and classical communication channels.

FIG. 2A is a schematic diagram of an example implementation of a QCP-EE.

FIG. 2B is a schematic diagram of an example implementation of a QCP-IE.

FIG. 2C is a schematic diagram of an example QCP-EE algorithm.

FIG. 2D is a schematic diagram of an example QCP-IE algorithm.

FIG. 3A is a schematic diagram of a file-to-graph encoding determined by converting between a file, an adjacency matrix, and a graph.

FIG. 3B is a schematic diagram of an example graph encoding quantum circuit.

FIG. 4 is a schematic diagram of an example random quantum circuit.

FIG. 5 is a schematic diagram of an example topology of a 27-qubit backend.

FIG. 6 is a schematic diagram of an example quantum circuit.

FIG. 7 is a prophetic plot of the overlap of example pairs of fingerprints.

FIG. 8 is a plot of the experimentally measured overlap of example pairs of fingerprints.

FIG. 9 is a histogram of the experimentally measured number of occurrences for each overlap of example pairs of fingerprints.

FIG. 10 is a schematic diagram of an example QCP-IE algorithm.

FIG. 11A is a schematic diagram of an example memory and an example adjacency array.

FIG. 11B is a schematic diagram of an example hypergraph.

FIG. 12 is a schematic diagram of an example quantum circuit.

FIGS. 13, 14, 15, 16, 17, 18, 19, and 20 are flowcharts of example QCPs.

### DETAILED DESCRIPTION

A hallmark of modern networks and databases is distributed replication of files, whether to improve availability, redundancy, or performance. However, replication may require protocols for integrity verification to ensure that copies of data have not diverged. This motivates the task of fingerprinting: mapping an input bitstring to a shorter bitstring (the fingerprint) in order to distinguish two input bitstrings with (arbitrarily) high probability.

Fingerprinting has been extensively studied in the so-called simultaneous message passing model. In this setting, fingerprints of two bitstrings A and B are sent to a referee to verify whether A=B with high probability. The goal may be to minimize the communication complexity of this process (i.e., the number of bits transferred). In some circumstances, it has been shown that there is an exponential advantage in communication complexity when utilizing quantum states for this task. Namely, for A and B each of N bits, there is a quantum protocol that succeeds with high probability using O(logN) qubits, while there is a known lower-bound of Ω(\sqrt{N}) classical bits in performing this task. Some quantum fingerprinting protocols may require constructing a complicated superposition state that generally takes time N to prepare on a quantum computer.

The subject matter disclosed herein includes a family of quantum comparing protocols (QCPs) that achieve provable advantages over classical protocols for checking the equivalence of files.

The first variant, QCP-EE (quantum comparing protocol, efficient encoding), uses n qubits to verify files with 2^{O(n)} bits, thus providing an exponential advantage in communication complexity, often the limiting factor in networked applications, over the best possible classical protocol. Moreover, QCP-EE can be gracefully scaled down for implementation on circuits with poly(n^{k}) depth to enable verification for files with O(n^{k}) bits, for arbitrarily large polynomials (i.e., high k). The quantum advantage of QCP-EE can be achieved by utilizing random circuit sampling that can be run on near-term hardware. The performance of QCP-EE was validated at scale through GPU (graphics processing unit) simulation.

The second variant, QCP-IE (quantum comparing protocol, incremental encoding), uses n qubits to verify files with O(n²) bits while supporting constant-time incremental updates to the fingerprint. In some examples, QCP-IE can operate utilizing only Clifford gates, thereby ensuring relatively modest overheads for error-corrected implementation.

Proof-of-concepts for both QCP-EE and QCP-IE were experimentally demonstrated through Qiskit Runtime on IBM quantum hardware, wherein 3-qubit pairs were used to perform verification checks between files.

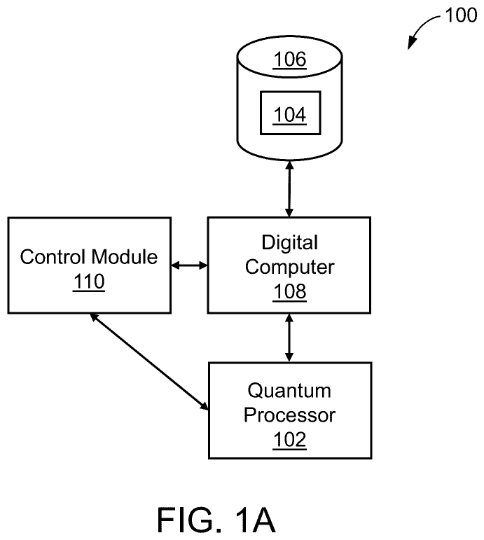

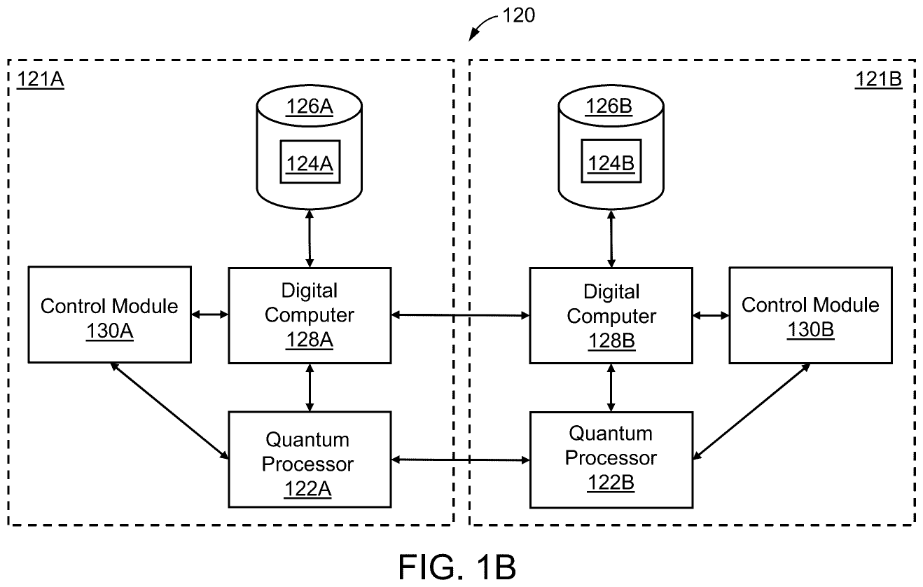

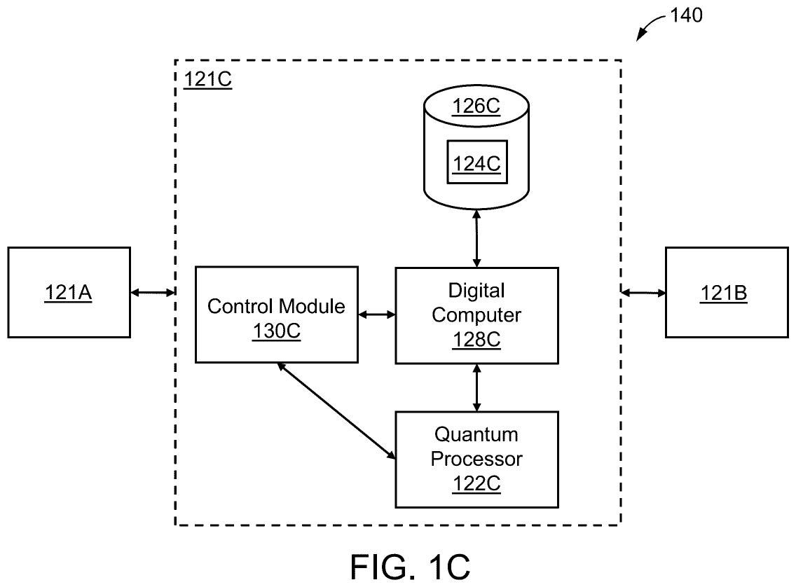

FIG. 1A shows an example hybrid quantum-classical computing system 100 that includes a quantum processor 102 comprising a plurality of quantum processing elements (not shown) associated with respective quantum states. The quantum processor 102 is configured to apply quantum gate operations comprising coupling operations (e.g., multi-qubit operations) and transformation operations (e.g., single-qubit operations) to a plurality of the quantum states according to a quantum circuit specification 104, stored on a storage medium 106, that defines a schedule for a plurality of quantum gate operations. A digital computer 108 is in communication with the quantum processor 102, the storage medium 106, and a control module 110. The digital computer 108 can be configured to receive information based at least in part on measurements of one or more quantum states associated with respective quantum processing elements of the quantum processor 102, and provide information for preparing one or more quantum states associated with respective quantum processing elements of the quantum processor 102 based at least in part on the received information or the quantum circuit specification 104. The control module 110 is in communication with the quantum processor 102 and is configured to control the applied coupling and transformation operations based on interactions with the digital computer 108 for managing processing of states of sequences of data. The applied coupling and transformation operations may be performed, for example, by using radio frequency electromagnetic fields coupled to a coupled array of superconducting circuits, or by using optical or radio frequency electromagnetic fields coupled to atoms or ions.

Referring again to FIG. 1A, the digital computer 108 can be responsible for a variety of tasks and can be implemented in any of a variety of configurations. For example, the digital computer 108 can include one or more processor cores, each comprising (1) at least one CPU or at least one GPU and (2) other circuitry, such as local cache memory for data or instructions. When there are multiple processor cores, there can be a bus or an interconnection network among the processor cores. Alternatively, the digital computer 108 can be implemented using a field programmable gate array (FPGA) or other programmable circuitry, such as an application specific integrated circuit (ASIC). There may also be a memory system that includes volatile memory, such as dynamic random-access memory (DRAM) modules, or non-volatile memory, such as a solid-state drive (SSD). Interface devices for interacting with the digital computer 108 can include any of a variety of communication ports for coupling to a variety of communication channels, including electronic, optical, or wireless communication channels. In some cases, the digital computer 108 can be integrated with or locally coupled to the quantum processor 102. In some cases, the quantum processor 102 or the digital computer 108 can be accessed from a client device in communication with a server over a network connection.

FIG. 1B shows an example networked quantum computing system 120 comprising two hybrid quantum-classical computing systems with quantum and classical communication channels. A first hybrid quantum-classical computing system 121A comprises a first quantum processor 122A, a first quantum circuit specification 124A stored on a first storage medium 126A, and a first digital computer 128A that is in communication with the first quantum processor 122A, the first storage medium 126A, and a first control module 130A. The first control module 130A is in communication with the first quantum processor 122A. A second hybrid quantum-classical computing system 121B comprises a second quantum processor 122B, a second quantum circuit specification 124B stored on a second storage medium 126B, and a second digital computer 128B that is in communication with the second quantum processor 122B, the second storage medium 126B, and a second control module 130B. The second control module 130B is in communication with the second quantum processor 122B. The first digital computer 128A and the second digital computer 128B are in communication via a classical communication channel that can transmit signals associated with classical information (e.g., binary information). The first quantum processor 122A and the second quantum processor 122B are in communication via a quantum communication channel that can transmit quantum information (e.g., associated with quantum states).

FIG. 1C shows an example network quantum computing system 140 comprising three hybrid quantum-classical computing systems with quantum and classical communication channels. A first hybrid quantum-classical computing system 121A and a second hybrid quantum-classical computing system 121B are each in classical and quantum communication with a third hybrid quantum-classical computing system 121C. The third hybrid quantum-classical computing system 121C comprises a third quantum processor 122C, a third quantum circuit specification 124C stored on a third storage medium 126C, and a third digital computer 128C that is in communication with the third quantum processor 122C, the third storage medium 126C, and a third control module 130C. The third control module 130C is in communication with the third quantum processor 122C.

In some examples, QCP-EE compares two N-bit files by transmitting as few as O(logN) qubits, thereby providing an exponential advantage over classical protocols. QCP-EE achieves an advantage in communication complexity (i.e., network I/O), which is often a limiting factor for modern distributed databases. For example, QCP-EE can be used to check if two O(2ⁿ) bit files are identical by sending only n qubits, which is an exponential advantage relative to the best-possible classical protocol. In a near-term setting with restricted quantum circuit gate counts and connectivity, QCP-EE can compare files of size O(n^{k}) bits for arbitrarily high k with a quantum circuit cost which scales as poly(n^{k}), whereas k=2 is the best that can be achieved classically while maintaining favorable scaling in the number of bits used.

In some examples, QCP-IE matches the best-possible scaling of classical protocols by transmitting as few as O(\sqrt{N}) qubits while achieving constant-time updates for incremental file changes. Thus, QCP-IE matches the k=2 quadratic scaling of the best possible classical protocol, but with the advantage of being incremental. For example, if a bit is flipped in an N-bit source file, the O(\sqrt{N}) qubit fingerprint can be updated in constant time, a property that no classical fingerprinting protocols apparently achieve nor are likely to achieve. QCP-IE has two somewhat counterintuitive features. First, QCP-IE can include one or more Clifford circuits, which are known to be classically simulated efficiently. However, a quantum advantage can persist nonetheless, since storing the stabilizers of an n-qubit stabilizer state may require O (n2) classical bits. Second, QCP-IE does not require Grover search or quantum random-access memory (QRAM), and instead may utilize an ordinary classical database. Such features are especially appealing for error-corrected implementations of QCP-IE. For example, by utilizing Clifford circuits QCP-IE can avoid the possibly massive overhead of magic state distillation for non-Clifford operations. Moreover, no special hardware for classical data loading is necessarily required.

The aforementioned asymptotic bounds for QCP-EE and QCP-IE have been further investigated by employing GPU-accelerated simulation to elucidate the real-world advantage achievable with QCP. Furthermore, experimental results for QCP have been collected from experiments executed on IBM quantum hardware.

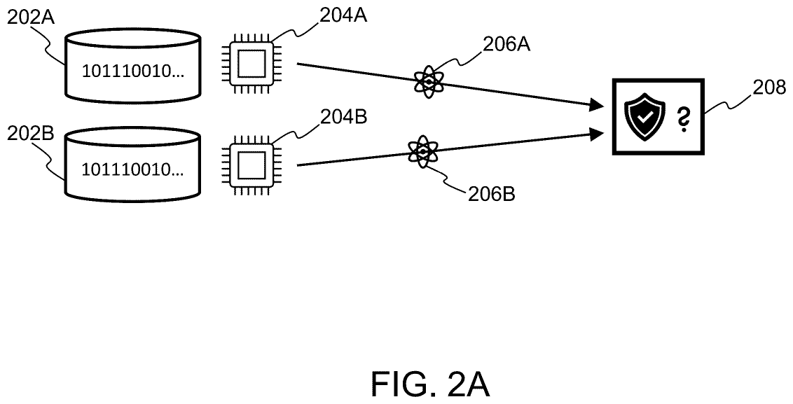

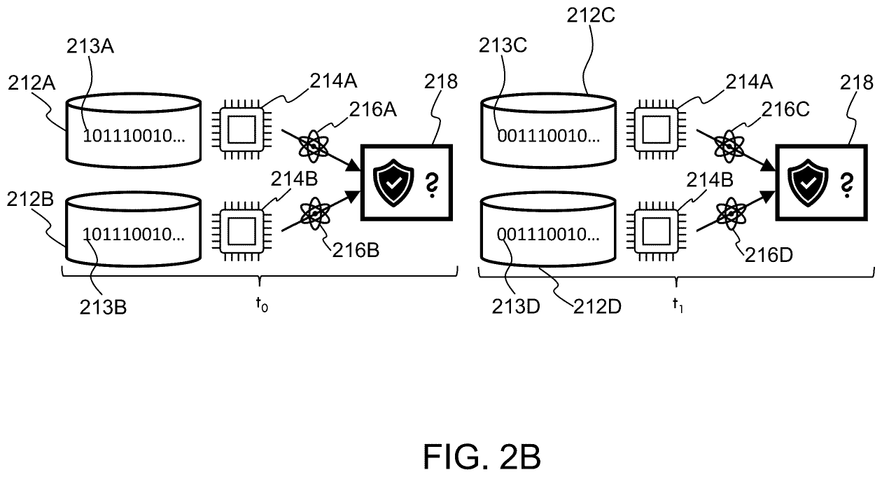

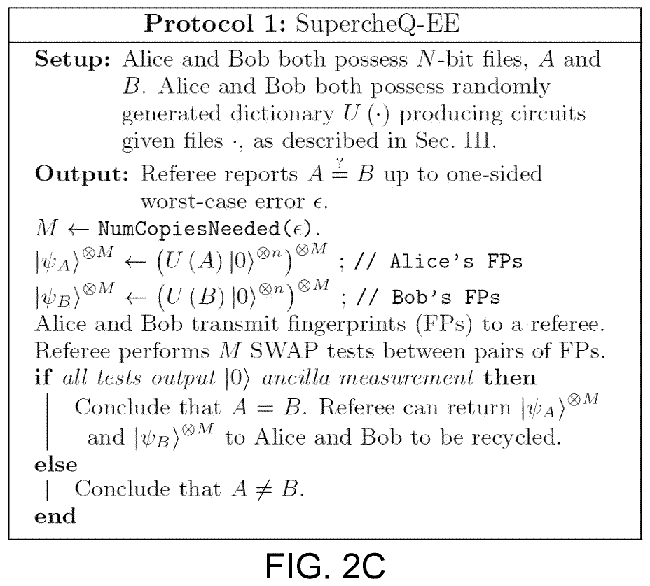

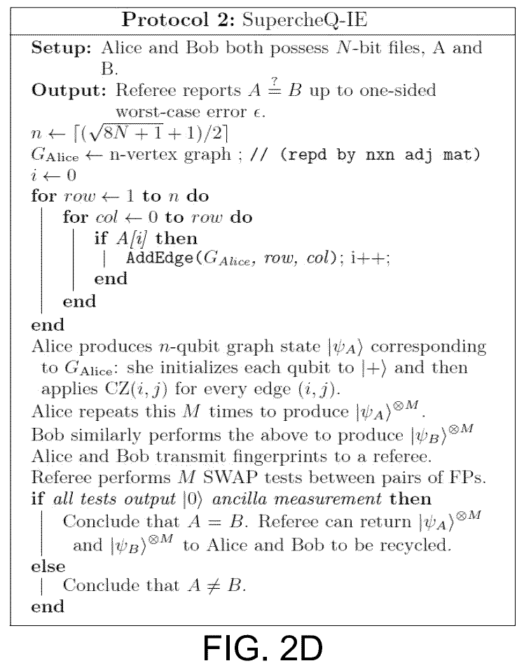

Throughout this disclosure, N will denote the number of classical bits composing a file of interest, while n will denote the number of qubits in the fingerprint corresponding to the file of interest. In some examples, the simultaneous message passing model (i.e., fingerprints of two bitstrings A and B are sent to a referee to verify whether A=B with high probability) is utilized to provide a framework for QCP. In general, QCP is not limited to the simultaneous message passage model and may be applied in other applications. The simultaneous message passing model may consider the communication complexity for Alice and Bob to send respective fingerprints to a third-party referee, as depicted in FIGS. 2A and 2B. In some examples, Alice and Bob can have private coins (i.e., uncorrelated randomness) and do not share a secure random key between the two of them.

FIG. 2A shows an example implementation of a QCP-EE. A first file 202A is used as input to a first quantum processor 204A (e.g., the quantum processor 102 shown in FIG. 1A). The first quantum processor 204A performs random circuit sampling to generate a first set of quantum states 206A based at least in part on the first file 202A. The first set of quantum states 206A are then transmitted to a fingerprint checking module 208. A second file 202B is used as input to a second quantum processor 204B. The second quantum processor 204B performs random circuit sampling to generate a second set of quantum states 206B based at least in part on the second file 202B. The second set of quantum states 206B are then transmitted to the fingerprint checking module 208. The fingerprint checking module 208 determines whether the first file 202A and the second file 202B are equivalent, with a certain probability, based at least in part on the first set of quantum states 206A and the second set of quantum states 206B. The first file 202A and the second file 202B each comprise N bits of information. In some examples, the first set of quantum states 206A and the second set of quantum states 206B each comprise O(logN) qubits. In other examples, the first set of quantum states 206A and the second set of quantum states 206B each comprise O(Nl/k) qubits with poly(k) cost.

FIG. 2B shows an example implementation of a QCP-IE. In a first period of time (t₀), a first file 212A comprising a first “1” digit 213A is used as input to a first quantum processor 214A (e.g., the quantum processor 102 shown in FIG. 1A). The first quantum processor 214A performs random circuit sampling to generate a first set of quantum states 216A based at least in part on the first file 212A. The first set of quantum states 216A are then transmitted to a fingerprint checking module 218. A second file 212B comprising a second “1” digit 213B is used as input to a second quantum processor 214B. The second quantum processor 214B performs random circuit sampling to generate a second set of quantum states 216B based at least in part on the second file 212B. The second set of quantum states 216B are then transmitted to the fingerprint checking module 208. The fingerprint checking module 218 determines whether the first file 212A and the second file 212B are equivalent, with a certain probability, based at least in part on the first set of quantum states 206A and the second set of quantum states 206B.

Referring again to FIG. 2B, in a second period of time (t1), a third file 212C comprising a first “0” digit 213C is used as input to the first quantum processor 214A. The first quantum processor 214A performs random circuit sampling to generate a third set of quantum states 216C based at least in part on the third file 212C. The third set of quantum states 216C are then transmitted to the fingerprint checking module 218. A fourth file 212D comprising a second “0” digit 213D is used as input to the second quantum processor 214B. The second quantum processor 214B performs random circuit sampling to generate a fourth set of quantum states 216D based at least in part on the fourth file 212D. The fourth set of quantum states 216D are then transmitted to the fingerprint checking module 218. The fingerprint checking module 218 determines whether the third file 212C and the fourth file 212D are equivalent, with a certain probability, based at least in part on the third set of quantum states 206C and the fourth set of quantum states 206D.

Referring again to FIG. 2B, in some examples, the first file 212A, the second file 212B, the third file 212C, and the fourth file 212D each comprise N bits of information. In such examples, the first set of quantum states 216A, the second set of quantum states 216B, the third set of quantum states 216C, and the fourth set of quantum states 216D each comprise O(\sqrt{N}) qubits. In other examples, the first, second, third, and fourth files do not comprise the same number of bits of information. In this example, the first file 212A and the second file 212B are identical to each other, and the third file 212C and the fourth file 212D are identical to each other. Furthermore, in this example the first file 212A and the second file 212B are identical to the third file 212C and the fourth file 212D except for the first bit, which undergoes a bit-flip. Therefore, the first file 212A and the second file 212B comprise a first “1” digit 213A and a second “1” digit 213B, respectively, while the third file 212C and the fourth file 212D comprise a first “0” digit 213C and a second “0” digit 213D, respectively. Such a bit-flip represents an incremental file change that can be updated in constant-time by QCP-IE.

Perhaps the simplest classical procedure for fingerprinting a file would be to send the entire file itself. In this case the number of bits comprising the fingerprint, n, is equal to the number of bits comprising the file, N (i.e., n=N). Another classical procedure comprises utilizing a hash function (e.g., SHA-256), which maps every file to a fingerprint (i.e., a message digest) comprising n=256 bits. In some cases, a hash comparison will suffice for checking the equivalence of two files. In general, however, hashing has a worst-case error of 100% since there will always exist differing files that collide with (i.e., result in) the same fingerprint (i.e., the same hash value). Such outcomes can be especially concerning in an adversarial or security-sensitive setting.

In a collision-free setting that approaches zero worst-case error with high probability, it is possible to improve upon the previously discussed n=N solution. In particular, it has been demonstrated that a classical protocol that uses private coins (i.e., uncorrelated randomness) to generate a fingerprint of approximately \sqrt{3N} bits can achieve a worst-case error of at most 5/11<0.5. This error can be suppressed exponentially by transmitting k independent fingerprints to reduce the worst-case error to ( 5/11)k. This quadratic improvement over naive fingerprinting is the optimal classically achievable improvement, such that the best a classical fingerprinting algorithm can do is to represent N classical bits with a fingerprint of size Θ(\sqrt{N}) bits.

However, a quantum fingerprint of size n=O(logN) qubits can encode a file of N bits, thus providing an exponential advantage over the best possible classical fingerprint. Such quantum fingerprinting has been demonstrated experimentally on NMR qubits, as well as on photonic devices by adapting some techniques to optical implementations. Despite such successes, the quantum fingerprint states each associated with a respective file can be challenging to realize experimentally. One benefit of QCP-EE is to demonstrate that random circuit sampling can achieve the asymptotic behavior of quantum fingerprinting. Despite the fact that the randomized approach of QCP-EE is less efficient in absolute terms, it is motivated by quantum experiments that can be performed in the near-term and it scales to allow a graceful tradeoff between the fingerprint size and the cost of quantum state preparation. Although QCP-IE does not attain the exponential advantage of QCP-EE in terms of the number of qubits transmitted, by utilizing graph states it can implement a fingerprinting protocol that matches the scaling of the best possible classical protocol while allowing for incremental file updates that are not known to be possible at this time.

In general, a quantum fingerprinting protocol attempts to distinguish between different quantum fingerprints, for example, by utilizing fidelity estimation protocols to estimate the fidelity, | [symbol] ψᵢ|ψⱼ [symbol] |², of two fingerprint states |ψᵢ [symbol] and |ψⱼ [symbol] .

The most common protocol for estimating the fidelity is the standard SWAP test. In such a protocol, an ancilla qubit is initialized to the state |+). The ancilla qubit is then used as the control qubit of a controlled-SWAP that swaps corresponding qubits between the two quantum fingerprint states each associated with a respective file. Upon applying a Hadamard gate to the ancilla qubit, the probability of measuring |1) on the ancilla qubit corresponds to the fidelity of the two quantum fingerprint states. In particular, if the two quantum fingerprint states are identical, the fingerprint will always be |0), assuming ideal conditions (e.g., no noise processes). In quantum fingerprinting examples where there are multiple copies of Alice and Bob's fingerprints, a collective SWAP test using a derangement operator can be performed. This collective measurement can distinguish the two fingerprints with quadratically fewer copies than may otherwise be needed. In the photonic realm, variations of the Hong-Ou-Mandel effect for implementations with bosons provide another mechanism for measuring fidelities. Finally, another protocol for estimating fidelity is the destructive SWAP test, which reformulates the standard SWAP test in a more gate-efficient fashion that may only require quantum gate operations between corresponding qubit pairs of |ψ_{A} [symbol] and |ψ_{B} [symbol] .

One intuition behind QCP-EE is that Hilbert space is vast and can accommodate a massive number of distinguishable state vectors into a modest number of qubits. In some examples, quantum fingerprinting protocols achieve an exponential advantage over the best-possible classical protocol (i.e., log(N) versus \sqrt{N} scaling) in a descriptive fashion by identifying a set of N superpositions such that each pair of distinct superpositions has fidelity less than a specified constant. Then, with only a constant factor overhead of qubits, fingerprints can be distinguished with small one-sided error. Such a protocol can be achieved using one of many quantum circuits that estimate the fidelity.

QCP-EE builds on such examples in three ways. First, QCP-EE is prescriptive rather descriptive, such that the encodings for input states are explicitly given by specific choices of random quantum circuits. Second, as a corollary, QCP-EE is well-matched to recent experimental demonstrations of random circuit sampling, such as quantum supremacy and quantum volume. As demonstrated herein, there exists a procedure that constructs efficient fingerprints via quantum circuits constructed out of local gates in 1D chosen uniformly at random. Such a procedure is in stark contrast to the generic preparations of arbitrary superpositions proposed in the descriptive procedure, which may require large multiply-controlled quantum gate operations that can be challenging on near-term hardware. Third, QCP-EE can scale gracefully in circuit depth. In particular, if the quantum circuit depth for preparation of quantum fingerprints is restricted to be some poly( [symbol] ), the quantum circuit can still encode [symbol] bit files. This feature stems from efficient sampling from approximate unitary t-designs.

FIG. 2C shows an example QCP-EE algorithm. In the QCP-EE algorithm, there can be a high probability that a large numbers of samples from certain distributions of random states have low fidelity with one another (e.g., below 0.5). This then allows for state discrimination with high probability via a constant number of copies of each state, along with SWAP tests or other fidelity estimating protocols. Once states from this distribution are generated, the referee (e.g., the fingerprint checking module 208 of FIG. 2A) can successfully discriminate fingerprints with high probability via a small number of copies (e.g., scaling logarithmically in the target inverse-error) of each state. Specific prescriptions for generating such random states and pseudorandom states are provided below.

Referring again to FIG. 2C, one technical point is that Alice and Bob share the same random circuit sampling protocol in performing the QCP-EE algorithm. One approach for achieving such a setting is for Alice and Bob to have a shared random key, which would necessitate secure key exchange and which already has an efficient classical protocol. Instead, Alice and Bob can achieve this setting in principle by fixing the randomness in advance so that at runtime, the protocol is deterministic. In effect, this turns the QCP-EE protocol into a large lookup table, mapping the bits of each possible input file to a specific circuit chosen from random quantum circuits. The lookup table can be generated with true randomness, such as with the outcomes of a quantum random number generator. Such a lookup table correspond to the randomly generated dictionary U(⋅) described in FIG. 2C., where, for each ⋅ (i.e., file), either independent and identically distributed (i.i.d.) Haar-random or i.i.d. approximate t-design circuits are chosen. While this approach rigorously satisfies the constraints of the simultaneous message passing setting, the lookup table may be impractically large. However, this disclosure includes a description of a possibly more practical approach involving pseudorandomness, which has been numerically tested.

The exponential-advantage invocation of QCP-EE is capitulated in the following Theorem that is proved later in this disclosure.

Theorem 0.1: Suppose 1.4²^{ⁿ} n-qubit states are Haar-randomly drawn. The probability that any pair has fidelity exceeding 0.5 vanishes as n→∞.

This result can be understood intuitively as a consequence of the birthday paradox. In particular, it is known that it is possible to encode 2²^{ⁿ} states, each corresponding to a length-2ⁿ bitstring, into n qubits, such that the maximum fidelity between two states is smaller than a constant. Regarding the double exponential: only one of the exponentials is noteworthy because n classical bits already naturally encode 2ⁿ length-n bitstrings. Intuitively, this means that the Hilbert space of n qubits has 2²^{ⁿ} sufficiently distinguishable containers. If drawing from these containers in a Haar-random fashion, how draws are there before a collision? While theoretically possible, it would be extremely unlikely that 2²^{ⁿ} random draws would perfectly land in separate containers. However, the birthday paradox states that for o(\sqrt{2²^{ⁿ}}) draws, for example 1.4²^{ⁿ}, the collision probability approaches 0 in the limit of large n. Without intending to be bound by theory, this intuitive reasoning is formally described below as example theorems with proofs. Though this approach is less efficient than certain other quantum approaches (e.g., by a square root scaling factor), QCP-EE retains an exponential advantage in communication complexity over the optimal classical protocols.

Generating an n-qubit Haar-random unitary (i.e., from SU(2ⁿ)) requires approximately exp(n) cost in both number of two-qubit quantum gate operations and classical random bits. This may be tolerable because Alice and Bob's files comprise approximately 2ⁿ bits, so in this sense the fingerprint preparation takes time polynomial in the size of the file. However, it motivates the study of approximate Haar-random states, which can be achieved in much shallower circuit depth for any given n and generally require less entanglement between subsets of qubits.

Here the preparation of quantum fingerprints via approximate unitary t-designs is considered. Informally, these are distributions over SU(2ⁿ) with first t moments approximately equal to those of the Haar distribution, although a more formal definition is provided below. These classes of random circuits are important theoretically, as there exist known methods for efficiently sampling from such distributions via choosing local quantum gate operations on a d-dimensional connectivity graph uniformly at random. For simplicity, the 1D case is considered here, although other cases are in general possible. One key result described in Theorem 0.2 is that this weaker notion of randomness suffices for generating more memory-efficient fingerprints than any classical fingerprint.

Theorem 0.2: Let [symbol] ≥1 be constant. There exists a class of 1D nearest-neighbor random circuits on n qubits of depth O( [symbol] ) such that by i.i.d. randomly drawing [symbol] states prepared from this class, the probability that any pair has fidelity exceeding 0.5 vanishes as n→∞.

In some examples, the QCP-EE algorithm shown in FIG. 2C may incorporate additional relaxations to aid in practical implementations of QCP-EE. Though such implementations may lose certain provable guarantees of low overlap of distinct quantum fingerprints in some simplified settings, it will be later shown that this setting is sufficient in practice.

A first relaxation is to consider shallower classes of random quantum circuits than those assumed in Theorem 0.2 for generating circuits from an approximate t-design. The proof of Theorem 0.2 relies on the best-known convergence results for sampling from such a distribution in 1D, which gives a depth of O(t^{4.01}(tn+lg(ϵ⁻¹))) for sufficiently large n when t=O(poly(n)). This is achieved via choosing uniformly at random nearest-neighbor gates in 1D in a “brickwork” pattern (i.e., alternating between gates on even pairs and odd pairs). However, it is conjectured that such circuits scramble to ϵ-approximate t-designs in depth O(nt+lg(ϵ⁻¹)). Assuming this reduces the circuit depth polynomial in Theorem 0.2 to O( [symbol] ). Furthermore, the upper-bounds on the fidelity in Theorems 0.1 and 0.2 are proven using standard worst-case bounds that may potentially be loose; if so, the circuit depths needed in practice may be even further reduced.

Second, it can be conjectured that any “sufficiently random” local quantum circuit yields sufficient scrambling for low fidelity between fingerprints. This conjecture is studied herein by considering a class of random quantum circuits suited for typical cold atom systems.

Finally, the cryptographic assumption of true randomness (e.g., by quantum random number generation) that was used to assure the fingerprinting performance and security of Theorems 0.1 and 0.2 can be relaxed. This assumption would be costly in practice, because it may require an inefficient lookup-table description of the fingerprinting protocol for any instance of randomness. Instead, the file to be fingerprinted will be used as a seed for pseudorandomly constructing quantum fingerprinting circuits. Empirical tests that validate the performance of this relaxation are disclosed herein.

One advantage of QCP-IE, not shared by QCP-EE or other fingerprinting protocols, is the ability to perform efficient incremental updates on fingerprints. In particular, if a fingerprint is generated for a file, and the file is subsequently modified by even a single bit flip, typically the fingerprint for the updated file must be generated from scratch.

QCP-IE is a protocol for generating quantum fingerprints that can be incrementally updated such that if file A′ results from bit flip(s) to A, the fingerprint |ψ_{A′} [symbol] can be updated via A. |ψ_{A′} [symbol] can be generated in constant time from |ψ_{A} [symbol] when A′ is the result of one or more incremental updates to file A. QCP-IE achieves a communication complexity of O(\sqrt{N}), matching the optimal non-incremental classical protocol. However, no known incremental classical protocol achieves this bound without cryptographic assumptions. For example, previous incremental approaches have relied on the hardness of discrete logarithm, which in fact has an efficient quantum algorithm. Subsequent work has noted other security issues with attempting to construct incremental hash functions. QCP-IE averts these issues by relying on an exact one-to-one mapping from files to quantum fingerprints.

QCP-IE includes two powerful ingredients. First, a file-to-graph encoding is used such that any N-bit file can be encoded into an n-qubit graph state, where n scales as ˜\sqrt{2N}. Second, the finding that distinct qubit graph states have bounded fidelity. Namely, for two distinct graph states |ψ_{A} [symbol] , |ψ_{B} [symbol] , | [symbol] ψ_{A}∥ψ_{B} [symbol] |²≤½. Therefore, efficient equality testing with low one-sided error via SWAP tests on one or more copies of |ψ_{A} [symbol] and |ψ_{B} [symbol] can be established. Taken together, these two facts can be used to construct an example QCP-IE algorithm.

FIG. 2D shows an example QCP-IE algorithm. Alice and Bob encode their N-bit files A and B as O(log(ϵ⁻¹)) graph states each with O(\sqrt{N}) qubits. Thus, with O(\sqrt{N}log(ϵ⁻¹)) qubits of communication, a referee is able to determine whether A and B are equal with a probability of at least 1−ϵ via O(log(ϵ⁻¹)) SWAP tests. For example, assume a bit in file A is toggled; how does this affect the fingerprint |ψ_{A} [symbol] ? As shown in FIG. 2D, only a single CZ operation on the graph state edge associated with the toggled bit is necessary to appropriately update the quantum fingerprint. This operation can also be extended using two ancilla qubits to complement all edges between two vertex subsets, in time scaling only linearly in the number of qubits in the sets rather than in the number of edges.

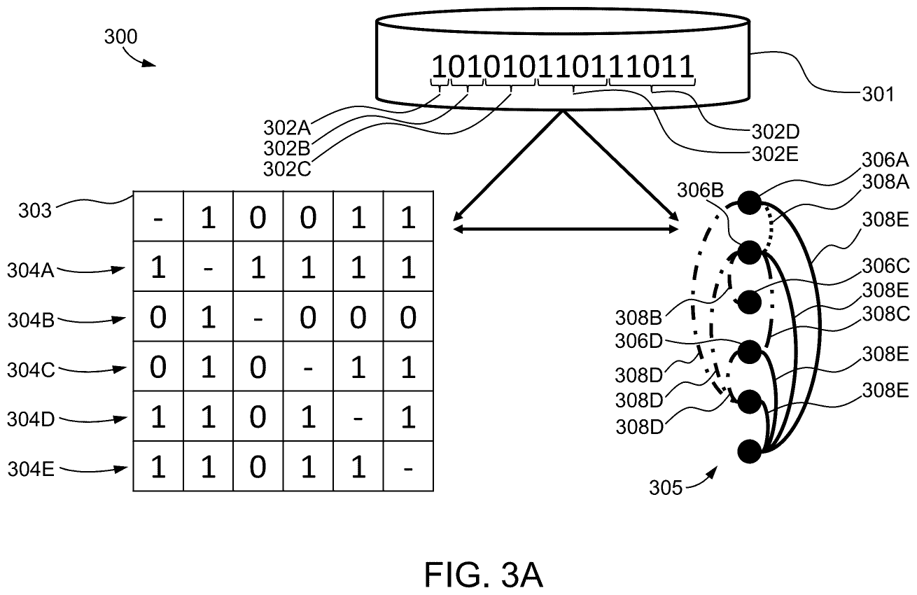

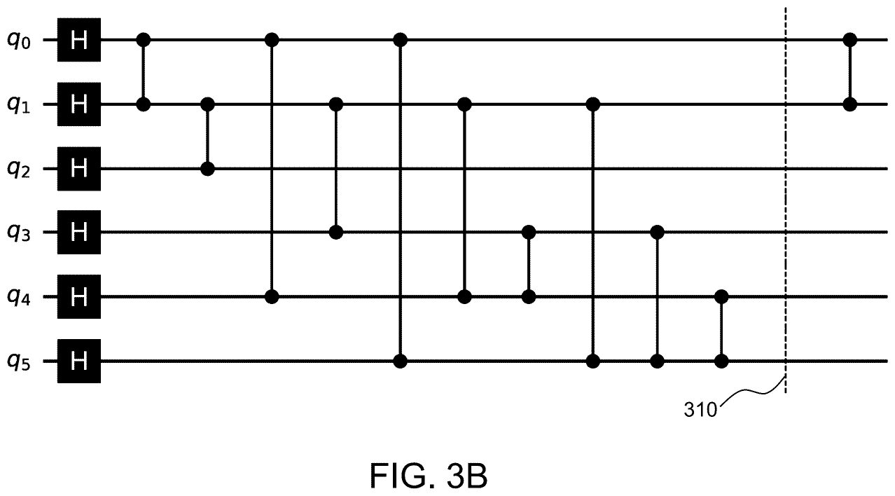

FIG. 3A shows an example file-to-graph encoding 300 determined by converting between a file 301, an adjacency matrix 303, and a graph 305. The file 301 comprises fifteen bits (N=15) and is encoded into the graph 305 comprising six vertices (n=6˜\sqrt{2N} asymptotically). The 6-qubit graph state corresponding to the graph 305 is the QCP-IE fingerprint. A first set of bits 302A, a second set of bits 302B, a third set of bits 302C, a fourth set of bits 302D, and a fifth set of bits 302E respectively correspond to both (1) a first set of elements 304A, a second set of elements 304B, a third set of elements 304C, a fourth set of elements 304D, and a fifth set of elements 304E in the adjacency matrix 303, and (2) a first set of edges 308A, a second set of edges 308B, a third set of edges 308C, a fourth set of edges 308D, and a fifth set of edges 308E in the graph 305. Each element in the adjacency matrix 303 is associated with one bit in the file 301 or one edge in the graph 305, except for the diagonal elements which correspond to loops (i.e., an edge that connects a vertex to itself) in the graph 305 and are thus ignored in this example. Each edge in the graph 305 is associated with one bit in the file 301 or one element in the adjacency matrix 303. In this example, each “1” bit in the file 301 corresponds to a “1” element in the adjacency matrix 303 and to the presence of an edge in the graph 305. Also in this example, each “0” bit in the file 301 corresponds to a “0” element in the adjacency matrix 303 and to the absence of an edge in the graph 305. Each set of bits is associated with a respective vertex and indicates the connection (i.e., edges) of that vertex to other vertices that correspond to bits earlier in the file. For example, the first set of bits 302A corresponds to a second vertex 306B. The first set of bits 302A comprises the bit “1”, indicating that the second vertex 306B is connected by an edge in the first set of edges 308A to a first vertex 306A. The third set of bits 302C comprises the bits “010”, indicating that a fourth vertex 306D is connected by an edge in the third set of edges 308C to the second vertex 306B and is not connected to the first vertex 306A or to a third vertex 306C.

The file-to-graph encoding (e.g., as shown in FIG. 3A) begins with the observation that any N-bit file can be encoded in row-major order as the entries of a strictly lower triangular n×n matrix, where n=┌½(\sqrt{8N+1}+1)┐, which scales as ˜\sqrt{2N}. This matrix, summed with its transpose, can then be interpreted as the adjacency matrix of a graph G, with n vertices. The graph G can in turn can be associated with a qubit graph state on n qubits. Namely, the graph's adjacency matrix Gᵢⱼ can be associated with the state stabilized by the Pauli strings: Sᵢ=XᵢΠ_{j≠i}Zⱼ^{G}^{ᵢⱼ} for i=1, . . . , n.

FIG. 3B shows an example graph encoding quantum circuit (in Qiskit) for generating a first graph state fingerprint (before line break 310) and updating the first graph state fingerprint for an incremental bit flip to generate a second graph state fingerprint (after line break 310). The first graph state fingerprint corresponds to the bits “101010110111011” of an original file (e.g., file 301 from FIG. 3A). Each of the ten “1” bits in the original file correspond to a CZ gate between two qubits. The final CZ gate (after line break 310) models an incremental update, flipping the first bit of the original file from “1” to “0”. In general, a graph state can be created by applying a Hadamard gate to each qubit, followed by a CZ gate corresponding to any row-column pair of the adjacency matrix that is 1 (i.e., corresponding to any edge in the graph). Subsequently, any bit flip to the original file can be performed with a single CZ gate to the appropriate pair of qubits. Because CZ gates commute with each other, the updated graph state faithfully reflects the updated file.

Alice and Bob's graph state fingerprints can be sent (e.g., when requested) to a referee. As in QCP-EE, the referee can use any of a variety of protocols previously described to check whether Alice and Bob's files are identical. If so, the graph state fingerprints can be recycled and returned to Alice and Bob. Recycling is particularly well-matched to the incremental scenario: if any updates were made to Alice's file while the referee was examining fingerprints, she can apply those updates when she receives the recycled fingerprint instead of needing to generate it from scratch.

Note that supporting bit flips is also sufficient to support general writes, which can be implemented as a read on the original file followed by a conditional flip. For instance, setting some bit to 0 is equivalent to reading it and flipping it if and only if the bit is currently 1. In addition, QCP-IE can support scenarios where the source is resized to a larger file, simply by adding a new qubit. This is equivalent to adding a new vertex to the graph state and therefore a new row to the adjacency matrix. There is also a possibility of supporting even more exotic incremental updates. For example, one can use two ancilla qubits to complement all edges between two vertex subsets in time scaling only linearly in the number of qubits in the sets, rather than in the number of edges; said otherwise, two ancilla qubits can be used to complement a block of the graph's adjacency matrix in a time that is linear in the dimensions of the block, rather than its volume. In summary, between individual bit flips, writes (by read-and-conditional-flip), resizing, and even more exotic operations, QCP-IE can support incremental updates for quite general changes to source files.

In some examples, Alice and Bob maintain graph state fingerprints corresponding to their respective databases. As updates are made to their respective databases, Alice and Bob can perform constant-time incremental updates to their graph states, possibly with modest batching for efficiency or to leverage available parallelism while executing multiple CZ gates.

As noted earlier, the graph encoding circuit of QCP-IE may be a Clifford circuit that is able to be simulated with only quadratic overhead that essentially amounts to storing the adjacency matrix of the graph state. In the context of future fault-tolerant implementations, this is significant because Clifford gates, which do not need costly magic state distillation, can be significantly cheaper to implement than non-Clifford gates. For instance, a Toffoli gate is roughly 100× slower than a Clifford gate for some surface codes. As such, QCP-IE may be one of the first target applications for early error-corrected devices.

Heuristic reasons for shallow-depth local random quantum circuits beyond those considered in Theorem 0.2 to achieve similar fingerprinting efficiency have been previously mentioned. In some examples, using seeding pseudorandomness avoids the need for an impractically large, randomly generated lookup table for constructing fingerprints. These assumptions have been tested on a variety of random quantum circuits over multiple file sizes, as described below.

The high encoding efficiency (e.g., up to exponential) of QCP-EE poses a computational challenge for simulations testing its performance. For example, if there are n qubits, one could fingerprint roughly 1.4²^{ⁿ} distinct files. Verifying that the inner product between pairs is small would incur a quadratic overhead on top of this double exponential, in the sense that roughly ½(1.4²^{ⁿ}×1.4²^{ⁿ}) inner products would be computed. While this scaling appears fundamentally unavoidable, owing to the high efficiency of QCP-EE, it motivates the consideration of GPU-accelerated approaches.

Prophetic simulations were performed with an NVIDIA A100 GPU for two core functions: state vector simulation and fidelity computation.

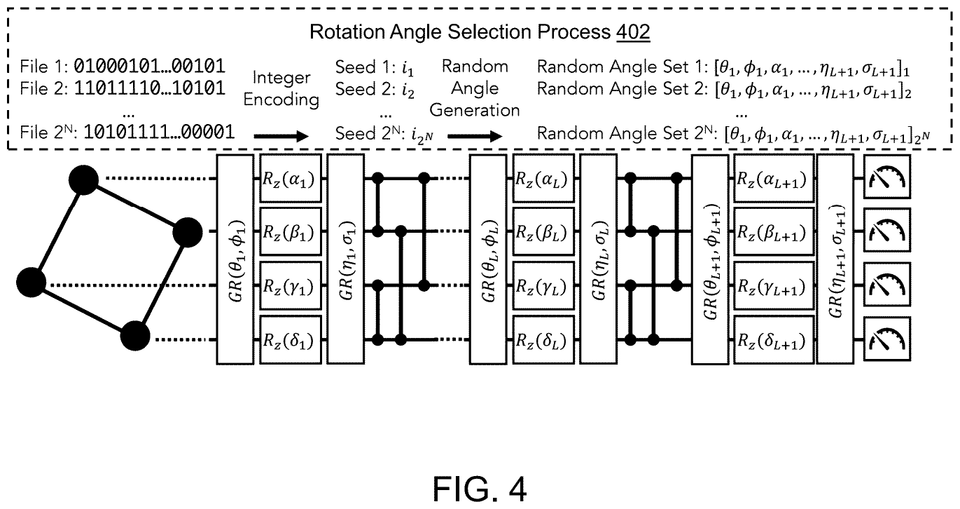

FIG. 4 shows an example random quantum circuit implementing QCP-EE. First, to compute state vectors for fingerprints, the cuState Vec library in the cuQuantum SDK was used with shallow-depth local random quantum circuits to generate quantum fingerprints in the noiseless regime. Inspired by atomic systems, considered in this example are random circuits given by the layered application of a first uniformly random global rotation gate:

$$G R ( θ , ϕ ) = exp ( - \frac{i}{2} {\sum }_{j = 1}^{n} ( cos ( θ ) {X}_{j} + sin ( ϕ ) {Y}_{j} ) ) , \qquad ( 1 )$$

uniformly random single-qubit Z rotations (e.g., R_{z}(α₁)) applied to one or more qubits, a second uniformly random global rotation gate, and pairs of CZ gates according to various qubit connectivities. A final application of the random single-qubit gates is then considered. A rotation angle selection process 402 shows how each rotation angle (e.g., θ₁, ϕ₁, α₁) is pseudorandomly chosen via seeding the NumPy pseudorandom number generator with the N-bit file to be fingerprinted. Thus, for each file a respective set of random angles is generated. After evolving under the random quantum circuit, the quantum state vector fingerprints are stored as rows of a large matrix X, and offload on NVIDIA GPUs the matrix multiplication to calculate the matrix product of overlaps

O=XX^{†}. (2)

The fidelity matrix F follows directly from O by taking the elementwise squared-magnitudes.

It can be seen that the random quantum circuit performance matches that of the Haar-random sampling even at relatively shallow depths, and that low overlap between distinct fingerprints is achieved in practice even when using the pseudorandom scheme. For instance, at a depth of just 5 layers, all trials in the nearest-neighbor case with 1024 input states have a maximum pairwise fingerprint fidelity below 0.05 (across 524k pairs). By a depth of just 7 layers, the performance is visually indistinguishable from true Haar-random sampling. Moreover, the performance between the nearest-neighbor and fully-connected cases is nearly indistinguishable. Although this may be an artifact of the small diameter of the 3-by-3 layout, it is nonetheless encouraging for hardware-efficient approaches.

Noise effects can be a major barrier to the implementation of useful quantum algorithms. In the noiseless case it can be beneficial to increase the depth of the random quantum circuit to increase the amount of scrambling. However, with the consideration of noise, increasing quantum circuit depth can adversely affect the QCP-EE protocol, for example by driving distinct random circuits towards the same maximally-mixed state. Thus, the sensitivity of the performance of QCP under the influence of different noise models has been investigated, including Pauli, thermal relaxation, and coherent noise channels.

In some examples, there can be a tradeoff that is introduced between the depth of the QCP and the maximum overlap that is observed between distinct seed files. In the noiseless case, it can be beneficial to increase the depth of the random circuit to increase the amount of scrambling. However, with the consideration of noise, an increase in circuit depth can adversely affect the QCP by driving unique random circuits towards the same maximally-mixed state.

Three separate noise models were considered and constructed using the Qiskit software package. Many quantum errors are often modeled as stochastic applications of Pauli matrices. A Pauli noise model was used to randomly apply a X, Y, or Z operation to any qubits participating in a single- or two-qubit quantum gate operation with probabilities p_{X}=p_{Z}=0.001 and p_{Y}=0.003 based on the recent benchmarking of a superconducting quantum circuit. A thermal noise model was used to assign an execution time to each gate, single-qubit rotations take 100 ns while two-qubit gates take 300 ns, and a characteristic T₁=50 ρs, T₂=70 μs time to each qubit. Finally, a coherent noise channel was used where there is a 1% chance of applying a π/6 over or under rotation to any qubit participating in a single- or two-qubit quantum gate operation. As the depth of the QCP is increased, it was observed that the maximum overlap first decreases, as seen in the noiseless simulations, but beyond a threshold depth the effects of noise reduce the ability to distinguish between distinct states. In some examples, the QCP is most sensitive to Pauli errors while it is relatively robust to thermal and coherent errors.

To experimentally validate QCP-EE, fingerprinting on n=3-qubit states was performed. In some instances, the best possible classical strategy with 3-qubit fingerprints would have a one-sided worst-case error of at least 50% when encoding 9 states (meanwhile, encoding 2³=8 states would trivially have zero error).

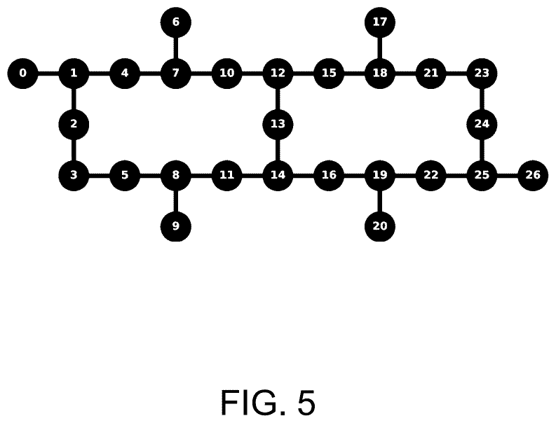

FIG. 5 shows an example topology of a 27-qubit backend. Fingerprinting experiments were executed on 7- and 6-qubit segments for standard and destructive SWAP tests respectively. In this example, the fingerprints were executed on the 27-qubit ibm_algiers backend from the Falcon family, a generation of quantum computers that have achieved quantum volume of 512 and CLOPS (Circuit Layer Operations Per Second) of 15,000. The high quantum volume is directly relevant to QCP because of the close relationship between quantum volume circuits and the approximate unitary t-designs relevant to QCP. Specifically, the quantum volume circuits are identical to a parallel random circuit (with fully-connected topology) model for approximate unitary t-designs. Thus, hardware with high quantum volume is also able to produce larger approximate unitary t-design circuits. In addition, high CLOPS ensures that the quantum computer can rapidly produce a fingerprint state, as measured in wall clock time.

Experiments for QCP-EE can include two steps: an encoding circuit for Alice and Bob, followed by an inner product measurement step performed by the referee. The encoding circuit used in this example is the local circuit model that is suitable for linear qubit topologies and has an approximate unitary t-design. For three qubits arranged as q₀-q₁-q₂, the circuit is a sequence of Haar-random SU(4) unitaries, applied at random to either the q₀-q₁ or q₂-q₃ pair. This model also nearly coincides with Quantum Volume, which would also allow q₀-q₂ gates (which would be recompiled to match the hardware topology).

To distinguish fingerprints, both the standard SWAP test as well as the destructive SWAP test were explored. The standard SWAP test involves a Controlled-SWAP between Alice and Bob's fingerprint qubits. The control qubit, initialized to |+ [symbol] , is measured in the X basis after the Controlled-SWAP, and measurement outcome probabilities is related to the fidelity between the two fingerprints. On limited-connectivity topologies, experimental results indicate it can be advantageous to use the destructive SWAP test. In this variant, one performs a CX between every corresponding pair of qubits in Alice and Bob's fingerprints, followed by a Hadamard on every pair of Alice's fingerprints. Then, each qubit is measured and classical post-processing techniques on the measured 2n bits yield the fidelity estimate. On a linear topology, the CX between every corresponding pair of qubits in Alice and Bob's fingerprints can be performed by a SWAP network. The SWAP network is the sequence of three SWAP gates; after these SWAPs, the qubits are arranged to that Alice and Bob's fingerprint qubits are interleaved. Thereafter, the three CX gates can be implemented with nearest-neighbor connectivity. The one disadvantage of this approach is that all qubits are measured at the end (hence the destructive name), so the fingerprints cannot be sent back to Alice and Bob to be reused.

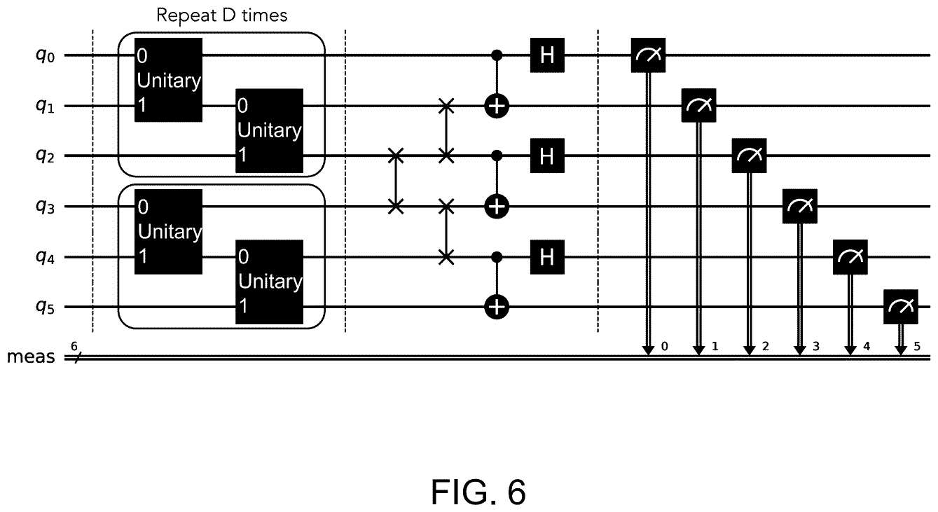

FIG. 6 shows an example quantum circuit for QCP-EE with a destructive SWAP test, which is well-suited to a linear qubit topology.

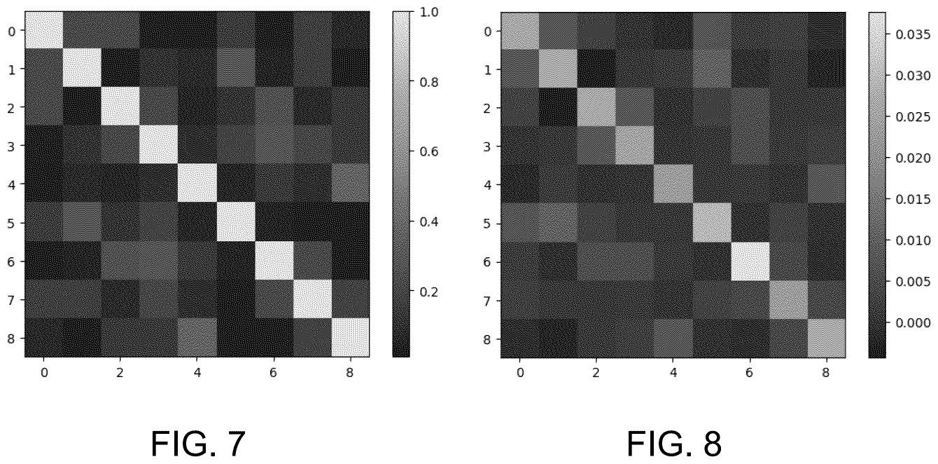

FIG. 7 shows a prophetic plot of the overlap of example pairs of fingerprints generated by using the example quantum circuit of FIG. 6. The diagonal has 1.0 elements because every fingerprint has 1.0 fidelity with itself, while for off-diagonal elements the fingerprints are all lower than 0.2.

FIG. 8 shows a plot of the experimentally measured overlap of example pairs of fingerprints generated by using the example quantum circuit of FIG. 6. The inner products (i.e., overlap) of off-diagonal elements coalesce towards 0.0, as would be expected in the limit of every state approaching the maximally mixed state due to noise. However, a clear pattern persists on the diagonal, such that the case of identical fingerprints can be separated from the off-diagonal case of differing fingerprints.

In both FIG. 7 and FIG. 8, a depth of just one layer is applied, exactly as shown in FIG. 6. The heatmaps represent the symmetric matrix of inner products between 9 input files.

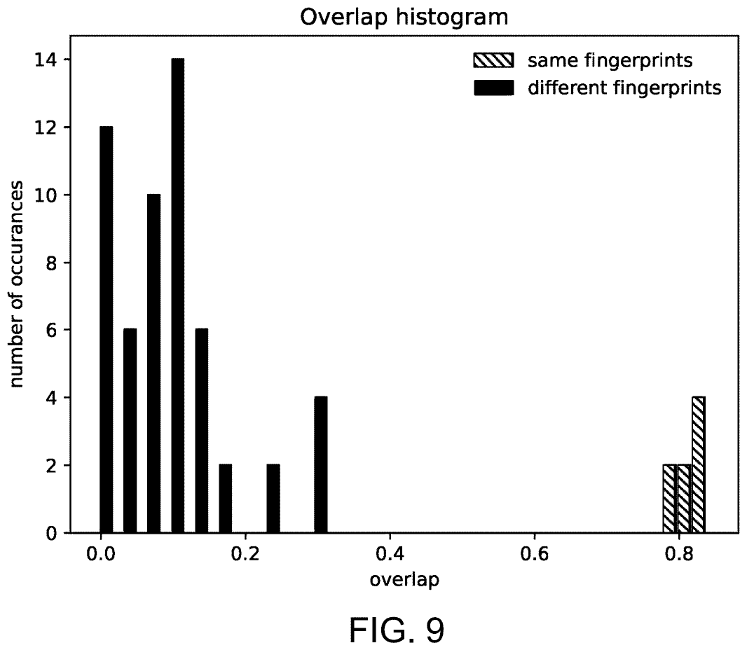

FIG. 9 shows a histogram of the experimentally measured number of occurrences for each overlap of the example pairs of fingerprints from FIG. 8.

In general, one could use qudits (d-dimensional systems, e.g., d=3 is a qutrit) for QCP-EE. Or, for QCP-IE, could use qudit graph states instead of qubit graph states. Additionally, analog protocols (e.g., replacing the random quantum circuit with a scrambling analog quench or a time-dependent Hamiltonian) or pulses may also be used to prepare the fingerprint states.

Fingerprinting to check that two files are equal can be beneficial throughout distributed data settings. For example, data transmission may be expensive. The cost of transmission can be a function of distance (e.g., interstellar transmission via satellites or to remote areas), data size (e.g., transmission of biological data, medical imagery, or government and military data), or logistical complexity (e.g., transmission of financial transactions across many tax jurisdictions). Additionally, the two endpoints (Alice and Bob) may not be able to communicate directly and may require mediation through a third-party referee (e.g., secure multi-party computation and game theoretic applications, such as double auctions). In some examples, data storage at the referee may be expensive. For example, consider an authentication device at the edge, linked to a cloud database. In this scenario, the authentication device may be the referee and the cloud database may be Alice (or Bob). Furthermore, QCP-IE may provide benefits as a fingerprinting protocol when data is replicated, versioned, or incrementally updated (e.g., data stored with a cloud provider).

In some examples, QCP may be used for checking consistency of inputs. For instance, in distributed financial transactions, institutions may want to ensure transactions are recorded at every node. Since transaction broadcasts can be lossy, QCP could be used to ensure that distributed parties received the same inputs. The financial transaction consensus problem in particular has high economic value. Another concrete application would be to RAID (Redundant Array of Inexpensive Disks); file storage redundancy could be provided by QCP rather than existing classical techniques.

In other examples, QCP may be used for checking consistency of processes. Even if it is assured that Alice and Bob have identical inputs, their processing techniques could be different. For example, if two nodes have different machine learning models, a third party may be interested in whether they produce the same outputs when provided with identical inputs. This use case maps well to VLSI design. In particular, minimizing communication within a chip is an important existing application for work on communication complexity. In the VLSI context, QCP could be used to check if two spatially separated registers or program counters are identical; in this setting, QCP could conceivably help lower power consumption for CPUs and GPUs. Other example applications of QCP include performing frequency checks for temporal updates. For example, in a distributed database application where Alice and Bob represent replicated nodes that are updated frequently, a referee may be interested in knowing the first instant at which inputs diverge. This may be particularly well-suited for QCP-IE, since incrementality may be critical.

Lastly, Alice (or Bob) may simply be a trusted delegate of the referee. For instance, suppose that the referee stores Bob's authentication credentials on the cloud with Alice. When Bob wishes to authenticate into the referee's access system, Bob can send a fingerprint of his credentials to the referee. When the referee tests against the (potentially) matching fingerprint from Alice, they can make a decision as to whether Bob has valid authentication tokens.

Consider two randomly drawn N-qubit states, |ψᵢ [symbol] and |ψⱼ [symbol] . The fidelity between these two random states is the square of their inner product: Fᵢⱼ=| [symbol] ψᵢ|ψⱼ [symbol] |².

Theorem 0.1 Proof: In this case, the probability density for Fᵢⱼ, when |ψᵢ [symbol] and |ψⱼ [symbol] are drawn from the Haar-random measure, is p(f)=(2ⁿ−1)(1−f)²^{ⁿ}⁻². Note that this is a Beta(α, β) distribution with α=1, β=2ⁿ−1.

In general, the probability of the event

$${⋃}_{1 \leq i < j \leq K} {F}_{i j} > c$$

can be upper-bounded by some constant c. This event corresponds to K randomly drawn states all being pairwise distinguishable by SWAP tests, with one-sided error decaying as c^{M} when M SWAP tests are performed. In this example, let c=0.5 for parity with the QCP-IE numerics, since differing graph states have fidelity of at most 0.5. Then:

$$\begin{matrix}Pr [ {⋃}_{1 \leq i < j \leq K} {F}_{i j} > 0.5 ] \leq {\sum }_{1 \leq i < j \leq K} P r [ {F}_{i j} > 0.5 ] \\ ( Union Bound ) \\ = \frac{K ( K - 1 )}{2} P r [ {F}_{i j} > 0.5 ] \\ = \frac{K ( K - 1 )}{2} {( \frac{1}{2} )}^{{2}^{n} - 1} \\ ( CDF of Beta dist . ) \\ = \frac{K ( K - 1 )}{{2}^{{2}^{n}}} .\end{matrix} \qquad ( 3 )$$

For K∈o(\sqrt{2²^{ⁿ}}), for example K=1.4²^{ⁿ}, the probability of an indistinguishable pair approaches 0 as n→∞. For example, even at just n=20, this probability is upper bounded by ˜10⁻⁹⁰⁰⁰.

Approximate Haar sampling techniques accomplished by approximate unitary t-designs are explored below. A more formal definition of the notion of t-designs, specifically approximate t-designs under the monomial measure, with a focus on qubits.

Monomial definition of approximate t-designs: μ is a monomial-based ϵ-approximate t-design on n qubits if all degree t′≤t monomials are within ϵ2^{-nt′} of those of the Haar measure.

Armed with this definition, Theorem 0.2 can now be proven.

Theorem 0.2 Proof: Let Uᵢ be i.i.d. drawn from an ϵ-approximate unitary t-design under the monomial measure, and let |ψᵢ [symbol] =Uᵢ|0 [symbol] . Let \tilde{F}ᵢⱼ be the random variable:

\tilde{F}ᵢⱼ=| [symbol] ψᵢ∥ψⱼ [symbol] ², (4)

and Fᵢⱼ the same for Haar-random states. Since Fᵢⱼ˜Beta(1, 2ⁿ−1), the moments are given by:

$$E [ {F}_{i j}^{t} ] = {\prod }_{i = 0}^{t - 1} \frac{α + i}{α + β + i} = {\prod }_{i = 1}^{t} \frac{i}{{2}^{n} + i - 1} \leq \frac{{t}^{t}}{{2}^{nt}} . \qquad ( 5 )$$

As Uᵢ are i.i.d. drawn from an e-approximate unitary t-design under the monomial measure, and as the tth moment of the fidelity can be written as a sum of 2^{nt} monomial terms, then:

$$\vert E [ {\tilde{F}}_{i j}^{t} ] - E [ {F}_{i j}^{t} ] \vert \leq \frac{{t}^{t}}{{2}^{nt}} + {2}^{nt} ϵ . \qquad ( 6 )$$

Markov's inequality then provides that:

$$Pr [ {\tilde{F}}_{i j} > 0.5 ] \leq \frac{E [ {( {\tilde{F}}_{i j} )}^{t} ]}{{( 0.5 )}^{t}} \leq {2}^{t} ( {2}^{nt} ϵ + \frac{{t}^{t}}{{2}^{nt}} ) . \qquad ( 7 )$$

Applying the Union Bound as in Equation 3 yields:

$$Pr [ {⋃}_{1 \leq i < j \leq K} {\tilde{F}}_{i j} > 0.5 ] \leq \frac{K ( K - 1 )}{2} ( {2}^{t ( n + 1 )} ϵ + \frac{{t}^{t}}{{2}^{t ( n - 1 )}} ) . \qquad ( 8 )$$

Now let t= [symbol] and ϵ= [symbol] Recall that for sufficiently large n, there exist nearest-neighbor random quantum circuits in 1D that sample from this distribution in depth O(t^{4+o(1)}(nt+lg(ϵ⁻¹)))=O( [symbol] ), such that:

$$Pr [ {⋃}_{1 \leq i < j \leq K} {\tilde{F}}_{i j} > 0.5 ] \leq \frac{K ( K - 1 )}{2} ( 1 + {2}^{( ℓ - 1 ) {n}^{ℓ - 1} l g ( n )} ) {2}^{- {n}^{ℓ - 1} ( n - 1 )} . \qquad ( 9 )$$

$$Let K = 1. {4}^{{n}^{ℓ}} . Then ,$$

$$Pr [ {⋃}_{1 \leq i < j \leq K} {\tilde{F}}_{i j} > 0.5 ] = O ( {2}^{- ( 1 - 2 l g ( 1.4 ) + o ( 1 ) ) {n}^{ℓ}} ) \to 0 . \qquad ( 10 )$$

In some examples, a greater information-compression factor may be achieved by considering hypergraphs, which generalize traditional graphs (i.e., graphs that contain edges that connect pairs of nodes) so that hyperedges can connect (i.e., contain) two or more nodes (i.e., instances). Herein, a k-hypergraph denotes the case where each hyperedge has cardinality k. The cardinality of a hyperedge denotes how many vertices are included in the hyperedge (e.g., a traditional graph with edges between two nodes has a cardinality of k=2). Thus, for a k-hypergraph with n vertices, the number of possible hyperedges is n choose k, which scales as O(n^{k}).

The file-to-graph encoding in QCP-IE can accordingly be replaced with a file-to-hypergraph encoding with some modifications of the previously described QCP-IE algorithm. In the file-to-hypergraph encoding, each bit of a file can be associated with the presence (or lack) of a hyperedge. Rather than the adjacency matrix used in the file-to-graph encoding, hypergraphs can be conceptualized by an adjacency array (also referred to as an adjacency hypercube), with permutation symmetries such that elements associated with (i, j, k) and (k, j, i) (and all other permutations), in a k=3 example, are in agreement. If k=4, the permutation symmetries are such that elements associated with (i, j, k, l) and (l, j, k, i) (and all other permutations) are in agreement. In general, a hypergraph may include hyperedges with different cardinalities. Asymptotically the scaling of the number of possible hyperedges can depend on the largest cardinality of the hyperedges, but the number of possible hyperedges can increase (e.g., by a constant factor) by allowing additional lower cardinality hyperedges. For example, a hypergraph may have hyperedges with a cardinality of 3 represented by an adjacency array, in addition to edges with a cardinality of 2 represented by an adjacency matrix.

For a given k-hypergraph on n vertices, a hypergraph state can be associated with n qubits that generalizes the traditional graph state. In particular, initialization may include generating a uniform superposition with Hadamard gates applied to each qubit. Then, for each hyperedge, a corresponding C^{k-1}Z gate (i.e., a multiply-controlled Z gate with k−1 control qubits and one target qubit) can be applied. Among the k qubits associated with a hyperedge, the choice of which of the k qubits are control qubits and which is a target qubit can be arbitrary, since all permutations perform the same C^{k-1}Z gate. Notice that for k=2, this recovers the procedure used for a traditional graph state, where each edge (i, j) has a corresponding CZ gate between qubits i and j.

As in the case of a traditional graph, the hypergraph encoding can use a SWAP test to distinguish two hypergraph states, |A [symbol] and |B [symbol] , and therefore their corresponding source files. In particular, if the two hypergraph states are identical (i.e., the two files are identical) the squared overlap | [symbol] ψ_{A}|ψ_{B} [symbol] ² is 1, meaning that the SWAP test will report that the two files are identical, unless experimental errors occur. However, if the hypergraph states differ (i.e., the source files differ), the overlap is at most

$$1 - \frac{1}{{2}^{k - 1}} ,$$

since the maximum possible overlap is the expected value of C^{k-1}Z on the uniform superposition state. For instance, the maximum possible squared-overlap for distinct 3-hypergraphs is 75%; for 4-hypergraphs, 87.5%, and so forth. For any fixed k though, there remains a macroscopic separation constant between distinct hypergraphs, thereby allowing hypergraphs to be distinguished with a one-sided error that is exponentially suppressed in the number of hypergraph state copies used or by repeating the algorithm multiple times.

As in the case of a traditional graph encoding, one can perform a collective SWAP test in the hypergraph encoding example when there are multiple copies of Alice and Bob's fingerprints by using a derangement operator. This collective measurement may be able to distinguish the two fingerprints with fewer copies than otherwise needed in non-collective measurements.

An advantage of encoding a file as a k-hypergraph is that there can be a greater information compression opportunity relative to an ordinary traditional graph. For example, a file with N bits can be encoded into a 3-hypergraph state of O( [symbol] ) qubits, which is asymptotically smaller than the O( [symbol] ) qubit size that is possible with a 2-hypergraph state (i.e., a graph state). Recall that the best possible classical approach for fingerprinting has square root scaling, such that the file-to-hypergraph encoding can attain an arbitrarily-high polynomial advantage (i.e., N bits→O( [symbol] ) qubits) while retaining the incrementality property of enabling constant-time updates to incremental data changes.

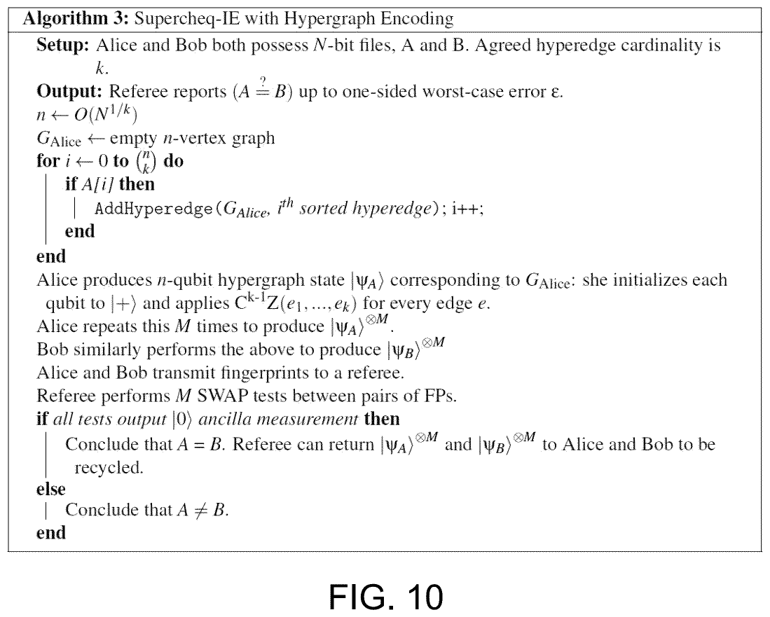

FIG. 10 shows an example QCP-IE algorithm that utilizes hypergraphs. At a high-level, level, the QCP-IE algorithm can include the following steps. The algorithm can interpret bits of file as a n-vertex k-hypergraph with a file-to-hypergraph encoding. Each bit is associated with a hyperedge. The algorithm can prepare an n-qubit uniform superposition state (e.g., by applying a Hadamard gate to each qubit). The algorithm can, for each of the k-hyperedges, apply a C^{k-1}Z gate to encode a hypergraph-state associated with a file or two or more bits of information. The algorithm can include performing equality testing (e.g., by using a SWAP test) for two or more hypergraph-state encodings.

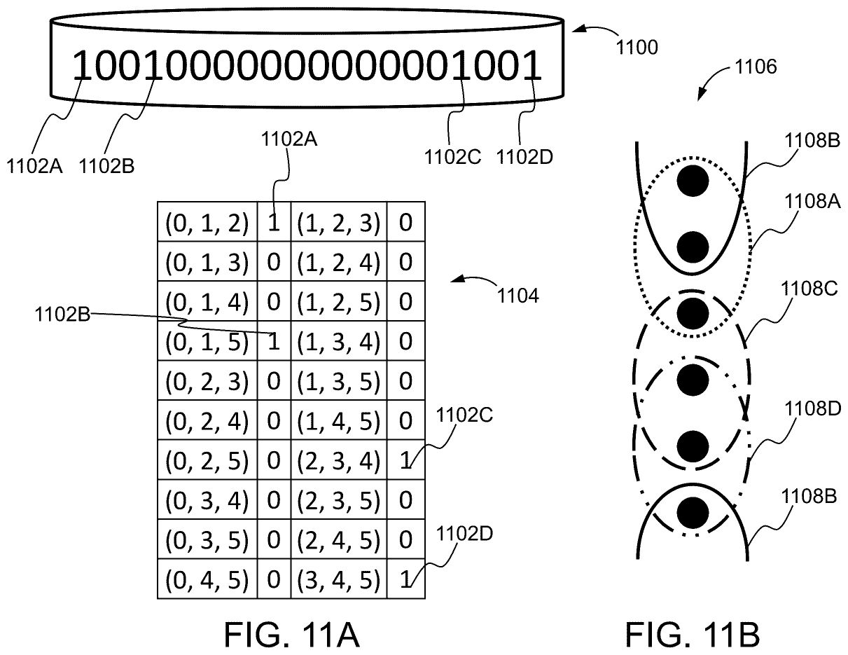

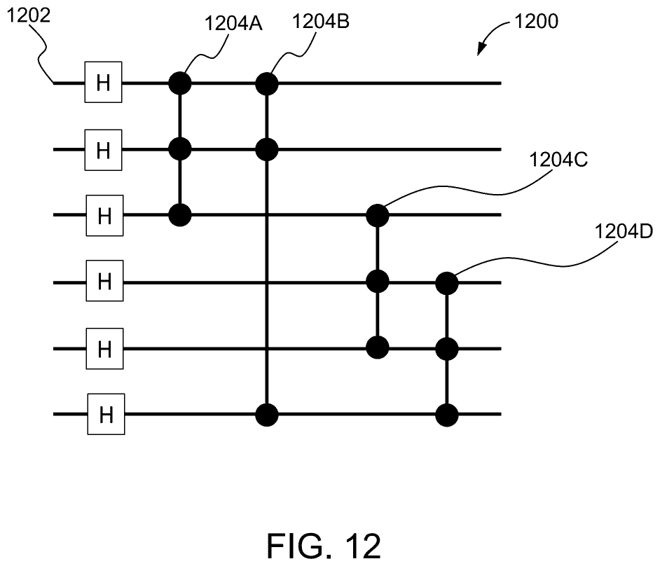

To demonstrate an example invocation of the hypergraph formulation of QCP-IE, FIGS. 11A, 11B, and 12 show the encoding for a 20-bit file.

FIG. 11A is a schematic diagram of an example memory and an example adjacency array storing 20 bits associated with a file.

FIG. 11B is a schematic diagram of an example hypergraph.

FIG. 12 is a schematic diagram of an example quantum circuit.

FIGS. 11A, 11B, and 12 collectively show an example invocation of file-to-hypergraph encoding for a file with 20 bits. In this example, a 20-bit file is encoded into the

$$( \begin{matrix}6 \\ 3\end{matrix} ) = 20$$

possible hyperedges of a 3-hypergraph on 6 vertexes. Since

$$( \begin{matrix}6 \\ 3\end{matrix} ) = 20 ,$$

the file can be represented with a 3-hypergraph on 6 vertices, and in turn, a 6-qubit state. Observe that a traditional graph on 6 vertices could only represent a

$$( \begin{matrix}6 \\ 2\end{matrix} ) = 15$$

bit file. Moreover, this advantage scales aggressively for higher N. For instance, a 1 MB (N=8×2³⁰) file would require a 133k qubits with a graph state, but only 50 qubits with a 10-hypergraph state. The corresponding hypergraph state preparation circuit on 6 qubits has a CCZ gate for each of the four hyperedges.

FIG. 11A shows an example memory 1100 and an example adjacency array 1104 each storing the same 20 bits associated with a file, the 20 bits comprising sixteen “0” digits, a first “1” 1102A, a second “1” 1102B, a third “1” 1102C, and a fourth “1” 1102D. In some examples, the 20 bits are mapped from the file stored in the memory 1100 to array elements of the adjacency array 1104.

FIG. 11B shows an example hypergraph 1106. A first hyperedge 1108A is associated with nodes (0, 1, 2) and corresponds to the first “1” 1102A. A second hyperedge 1108B is associated with nodes (0, 1, 5) and corresponds to the second “1” 1102B. A third hyperedge 1108C is associated with nodes (2, 3, 4) and corresponds to the third “1” 1102C. A fourth hyperedge 1108D is associated with nodes (3, 4, 5) and corresponds to the fourth “1” 1102D.

FIG. 12 shows an example quantum circuit 1200 comprising six qubits 1202. A Hadamard gate (H) is applied to each qubit 1202, placing each of the qubits 1202 in a superposition of two quantum states. A first CCZ gate 1204A is applied to the qubits 1202 associated with the nodes (0, 1, 2) that are included in the first hyperedge 1108A of FIG. 11B. A second CCZ gate 1204B is applied to the qubits 1202 associated with the nodes (0, 1, 5) that are included in the second hyperedge 1108B of FIG. 11B. A third CCZ gate 1204C is applied to the qubits 1202 associated with the nodes (2, 3, 4) that are included in the third hyperedge 1108C of FIG. 11B. A fourth CCZ gate 1204D is applied to the qubits 1202 associated with the nodes (3, 4, 5) that are included in the fourth hyperedge 1108D of FIG. 11B. For each CCZ gate, the choice of which two of the three qubits are control qubits and which is the target qubit can be arbitrary, as all permutations will perform the same CCZ gate amongst a given set of qubits. Furthermore, the order of the CCZ gates can be changed (e.g., the first CCZ gate 1204A can instead be performed after the second CCZ gate 1204B).

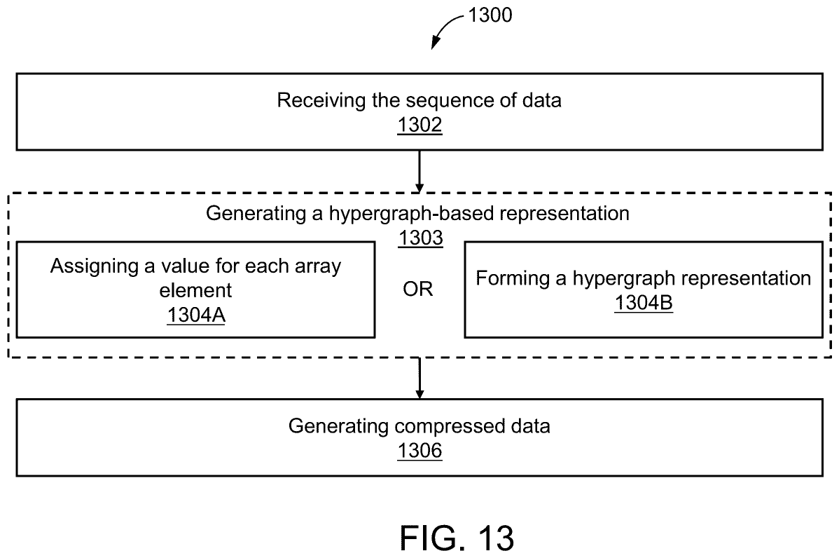

FIG. 13 shows a flowchart of an example QCP 1300 for compressing a sequence of data comprising a first number of bits. The QCP 1300 comprises receiving the sequence of data 1302 and generating a hypergraph-based representation 1303 based at least in part on the sequence of data, where the generating comprises at least one of (1) assigning a value for each array element 1304A in an adjacency array representation based on at least one bit in the sequence of data, or (2) forming a hypergraph representation 1304B where each hyperedge between two or more nodes corresponds to at least one bit in the sequence of data. The QCP 1300 further comprises generating compressed data associated with the sequence of data based at least in part on the hypergraph-based representation, where the compressed data comprises a second number of qubits less than the first number of bits.

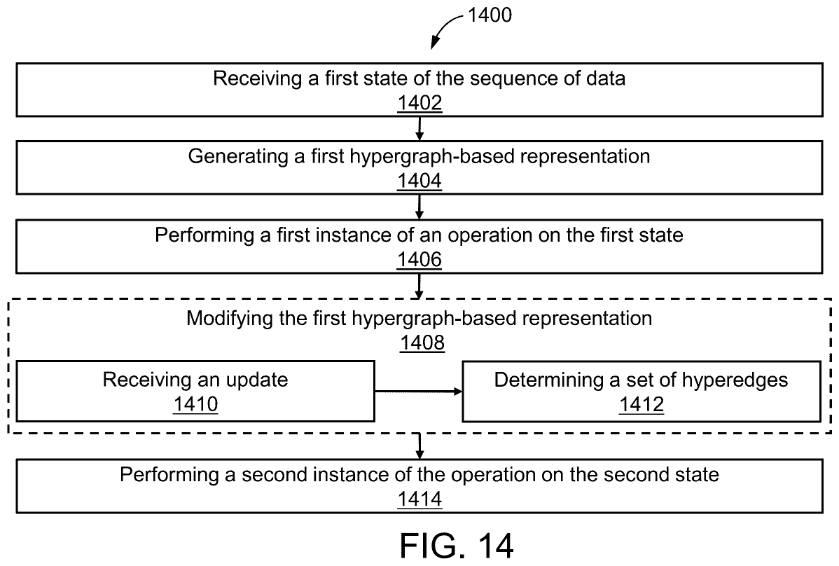

FIG. 14 shows a flowchart of an example QCP 1400 for processing states of a sequence of data. The QCP 1400 comprises receiving a first state of the sequence of data 1402, generating a first hypergraph-based representation 1404 based at least in part on the first state of the sequence of data, and performing a first instance of an operation on the first state 1406 of the sequence of data based at least in part on the first hypergraph-based representation. The QCP 1400 further comprises modifying the first hypergraph-based representation 1408 to generate a second hypergraph-based representation, where the modifying comprises (1) receiving an update 1410 comprising a portion of a second state of the sequence of data that differs from the first state of the sequence of data, where the update is less than the entire second state of the sequence of data, and (2) determining a set of hyperedges 1412 between nodes in a hypergraph corresponding to the second hypergraph-based representation based on corresponding bits in the update. The QCP 1400 further comprises performing a second instance of the operation on the second state 1414 of the sequence of data based at least in part on the second hypergraph-based representation.

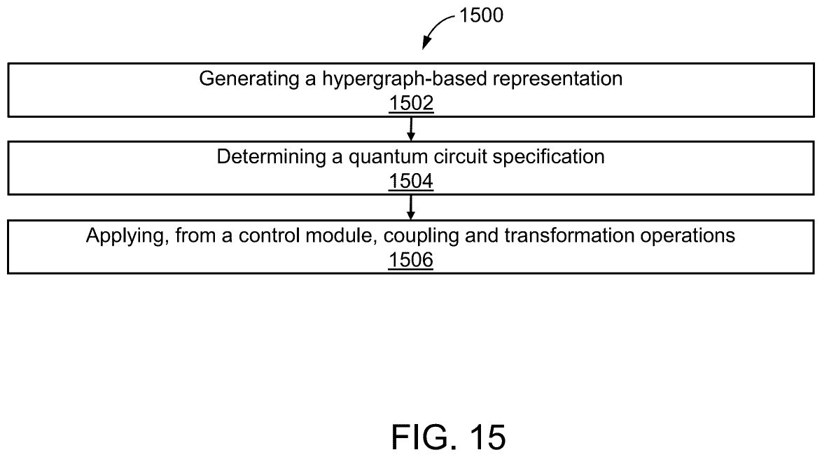

FIG. 15 shows a flowchart of an example QCP 1500 for preparing one or more quantum states associated with a sequence of data. The QCP 1500 comprises generating a hypergraph-based representation 1502 based at least in part on the sequence of data, determining a quantum circuit specification 1504 specifying a plurality of quantum gate operations, where the determining is based at least in part on the hypergraph-based representation, and applying, from a control module, coupling and transformation operations 1506 to a plurality of quantum states associated with respective quantum processing elements of a quantum processor based at least in part on the quantum circuit specification.

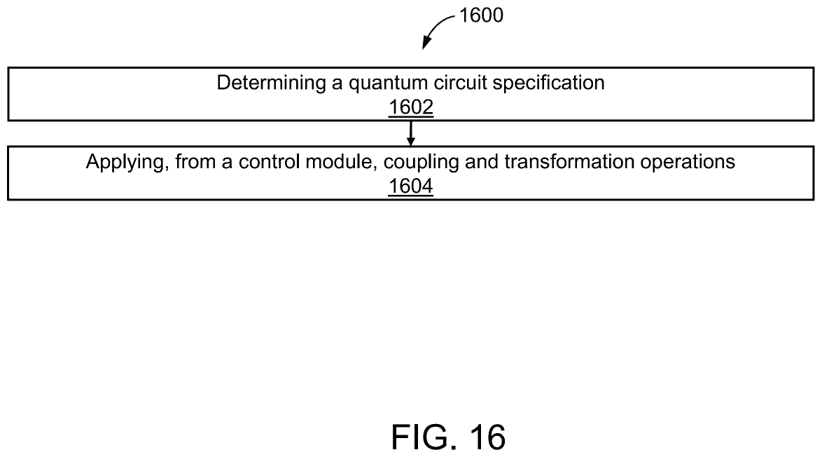

FIG. 16 shows a flowchart of an example QCP 1600 for preparing one or more quantum states associated with a sequence of data. The QCP 1600 comprises determining a quantum circuit specification 1602 specifying a plurality of quantum gate operations, where the determining is based at least in part on random circuit sampling and the sequence of data, and the sequence of data provides randomness for the random circuit sampling. The QCP 1600 further comprises applying, from a control module, coupling and transformation operations 1604 to a plurality of input quantum states associated with respective quantum processing elements of a quantum processor, based at least in part on the quantum circuit specification, to prepare one or more output quantum states associated with the sequence of data.

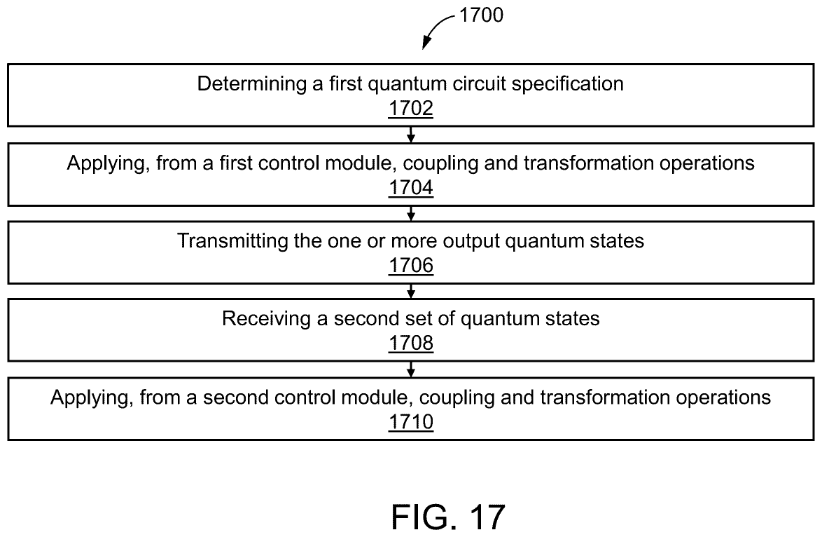

FIG. 17 shows a flowchart of an example QCP 1700 for comparing two or more sequences of data comprising a first sequence of data and a second sequence of data. The QCP 1700 comprises determining a first quantum circuit specification 1702 specifying a plurality of quantum gate operations, based at least in part on random circuit sampling and the first sequence of data, where the first sequence of data provides randomness for the random circuit sampling. The QCP 1700 further comprises applying, from a first control module, coupling and transformation operations 1704 to one or more input quantum states associated with respective quantum processing elements of a first quantum processor, based at least in part on the first quantum circuit specification, to prepare one or more output quantum states. The QCP 1700 further comprises transmitting the one or more output quantum states 1706 to a first set of quantum states associated with respective quantum processing elements of a second quantum processor. The QCP 1700 further comprises receiving, at respective quantum processing elements of the second quantum processor, a second set of quantum states 1708 associated with the second sequence of data. The QCP 1700 further comprises applying, from a second control module, coupling and transformation operations 1710 to one or more quantum states associated with respective quantum processing elements of the second quantum processor, based on a second quantum circuit specification, to compare a first pair of quantum states comprising a first quantum state from the first set of quantum states and a second quantum state from the second set of quantum states.

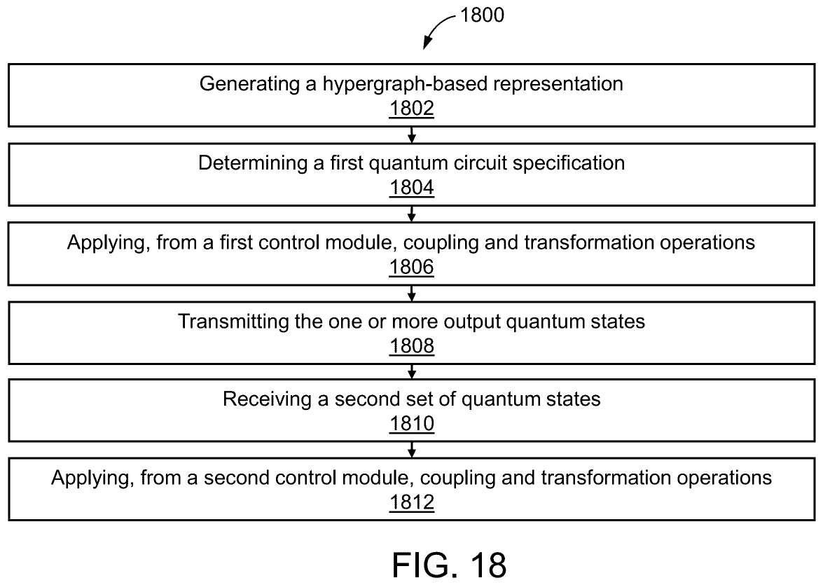

FIG. 18 shows a flowchart of an example QCP 1800 for comparing two or more sequences of data comprising a first sequence of data and a second sequence of data. The QCP 1800 comprises generating a hypergraph-based representation 1802 based at least in part on the first sequence of data and determining a first quantum circuit specification 1804 specifying a plurality of quantum gate operations, where the determining is based at least in part on the hypergraph-based representation. The QCP 1800 further comprises applying, from a first control module, coupling and transformation operations 1806 to one or more input quantum states associated with respective quantum processing elements of a first quantum processor, based at least in part on the first quantum circuit specification, to prepare one or more output quantum states. The QCP 1800 further comprises transmitting the one or more output quantum states 1808 to a first set of quantum states associated with respective quantum processing elements of a second quantum processor. The QCP 1800 further comprises receiving, at respective quantum processing elements of the second quantum processor, a second set of quantum states 1810 associated with the second sequence of data. The QCP 1800 further comprises applying, from a second control module, coupling and transformation operations 1812 to one or more quantum states associated with respective quantum processing elements of the second quantum processor to compare a first pair of quantum states comprising a first quantum state from the first set of quantum states and a second quantum state from the second set of quantum states.

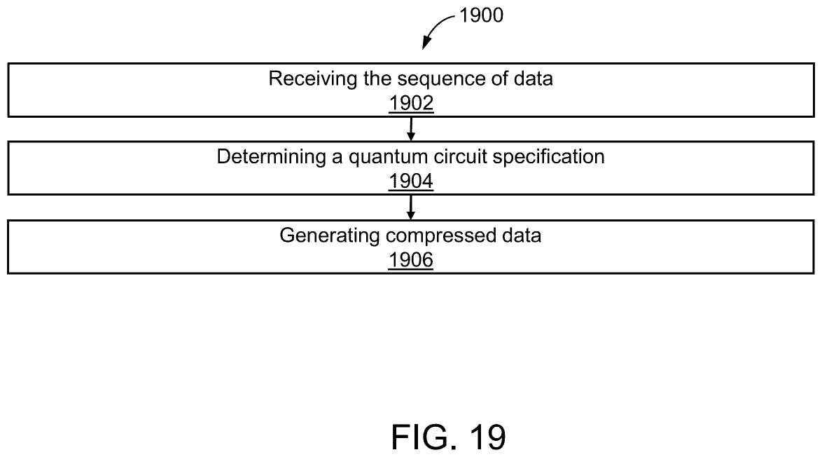

FIG. 19 shows a flowchart of an example QCP 1900 for compressing a sequence of data comprising a first number of bits. The QCP 1900 comprises receiving the sequence of data 1902, determining a quantum circuit specification 1904 specifying a plurality of quantum gate operations, where the determining is based at least in part on random circuit sampling and the sequence of data, and the sequence of data provides randomness for the random circuit sampling. The QCP 1900 further comprises generating compressed data 1906 associated with the sequence of data based at least in part on the quantum circuit specification, where the compressed data comprises a second number of qubits less than the first number of bits.

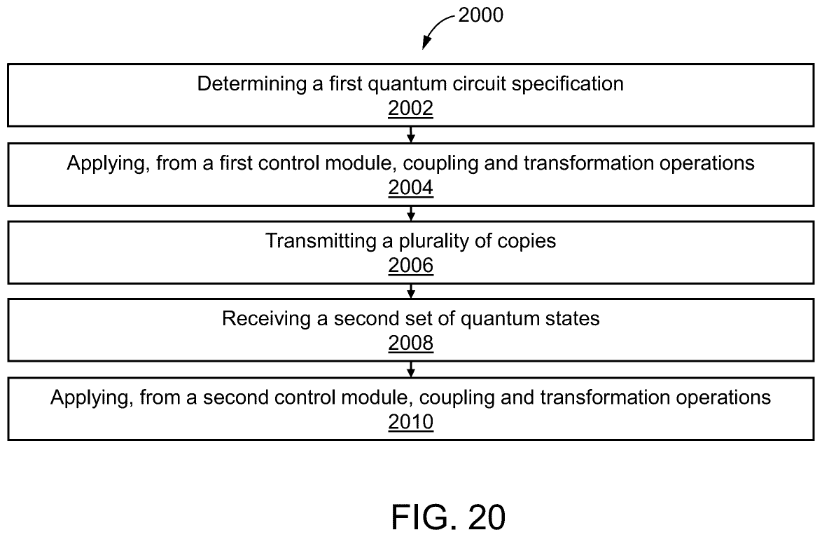

FIG. 20 shows a flowchart of an example QCP 2000 for comparing two or more sequences of data comprising a first sequence of data and a second sequence of data. The QCP 2000 comprises determining a first quantum circuit specification 2002 specifying a plurality of quantum gate operations, where the determining is based at least in part on the first sequence of data. The QCP 2000 further comprises applying, from a first control module, coupling and transformation operations 2004 to one or more quantum states associated with respective quantum processing elements of a first quantum processor, based at least in part on the first quantum circuit specification, to prepare one or more quantum states. The QCP 2000 further comprises transmitting a plurality of copies 2006 of the one or more prepared quantum states to a first set of quantum states associated with respective quantum processing elements of a second quantum processor. The QCP 2000 further comprises receiving, at respective quantum processing elements of the second quantum processor, a second set of quantum states 2008 associated with the second sequence of data. The QCP 2000 further comprises applying, from a second control module, coupling and transformation operations 2010 to a plurality of quantum states associated with respective quantum processing elements of the second quantum processor to compare a set of quantum state pairs, each quantum state pair comprising a quantum state in the first set of quantum states and a second quantum state in the second set of quantum states, where the comparing comprises performing a collective quantum state measurement over different respective copies of the one or more prepared quantum states.

The subject matter disclosed herein provides the ability to verify a large number of bits of information efficiently for security purposes. For example, a hardware provable unclonable function (PUF) provides a unique identifier for silicon chips or quantum hardware in a possibly small number of bits. The file-to-graph and file-to-hypergraph algorithms disclosed herein may be used to verify not only hardware, but also software and any configuration data that is important for the secure operation of an entire computing system. The computing system could be either entirely classical, or hybrid quantum and classical. For example, the algorithms could verify bits associated with the hardware (e.g., a PUF or a secret identifying bitstring), in addition to binary for the software components and any configuration data that is important.

In some examples, a hierarchical verification scheme may be used. In such examples, there would be some base system to verify that may include the hardware, a possibly small number of software components, and a possibly small amount of configuration data. Then incrementally larger numbers of software components and amounts of configuration data (including the base amounts), encoded either in increments of the additional bits (more efficient), or as a new encoding of the entire sum of bits each time (less efficient).

In some examples, by pre-communicating graph or hypergraph states, the algorithms disclosed herein can check the current system against some previous state of the system and verify that nothing has changed, up to some point in the hierarchy which includes increasing amounts of the software and configuration data.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for compressing a sequence of data comprising a first number of bits, the method comprising:
receiving the sequence of data;
generating a hypergraph-based representation based at least in part on the sequence of data, where the generating comprises at least one of:
assigning a value for each array element in an adjacency array representation based on at least one bit in the sequence of data, or
forming a hypergraph representation where each hyperedge between two or more nodes corresponds to at least one bit in the sequence of data; and
generating compressed data associated with the sequence of data based at least in part on the hypergraph-based representation, where the compressed data comprises a second number of qubits less than the first number of bits.

2. The method of claim 1, where the adjacency array representation contains array elements indicating whether two or more nodes are adjacent or not in the hypergraph representation.

3. The method of claim 1, where the generating of the compressed data comprises preparing one or more quantum states based at least in part on the hypergraph-based representation.

4. The method of claim 1, further comprising using the compressed data as a fingerprint of the sequence of data.

5. The method of claim 1, where at least one of the hyperedges connects three or more nodes in the hypergraph representation.

6. The method of claim 1, where a first hyperedge connects a first number of nodes and a second hyperedge connects a second number of nodes different from the first number of nodes.

7. A method for processing states of a sequence of data, the method comprising:
receiving a first state of the sequence of data;
generating a first hypergraph-based representation based at least in part on the first state of the sequence of data;
performing a first instance of an operation on the first state of the sequence of data based at least in part on the first hypergraph-based representation;
modifying the first hypergraph-based representation to generate a second hypergraph-based representation, where the modifying comprises:
receiving an update comprising a portion of a second state of the sequence of data that differs from the first state of the sequence of data, where the update is less than the entire second state of the sequence of data, and
determining a set of hyperedges between nodes in a hypergraph corresponding to the second hypergraph-based representation based on corresponding bits in the update; and
performing a second instance of the operation on the second state of the sequence of data based at least in part on the second hypergraph-based representation.

8. The method of claim 7, where the received update comprises two or more updates.

9. The method of claim 7, where the operation is a controlled-Z quantum gate operation.

10. A system for generating and transmitting quantum states, the system comprising:
a first computing device comprising one or more processors in communication with a first plurality of quantum storage elements;
a second computing device comprising one or more processors in communication with (1) a non-volatile memory, (2) a second plurality of quantum storage elements, and (3) control circuitry configured to apply quantum gate operations to the second plurality of the quantum storage elements, where the second computing device is configured to:
read a first sequence of data from the non-volatile memory, and
use the control circuitry to generate a first set of quantum states stored in the second plurality of quantum storage elements based at least in part on at least one of (1) a hypergraph-based representation associated with the first sequence of data or (2) random circuit sampling and the first sequence of data, where the first sequence of data provides randomness for the random circuit sampling; and
a quantum communication channel between the first computing device and the second computing device configured to transmit the first set of quantum states from the second computing device to the first computing device.

11. The system of claim 10, where the first computing device is configured to:
receive the first set of quantum states transmitted from the second computing device by the quantum communication channel, and
perform one or more measurements on (1) the first set of quantum states and (2) a second set of quantum states generated based at least in part on at least one of (A) a hypergraph-based representation associated with a second sequence of data or (B) random circuit sampling and the second sequence of data, where the second sequence of data provides randomness for the random circuit sampling.

12. The system of claim 11, where the first sequence of data is associated with at least one of (1) hardware included in the second computing device at a first time or (2) software loaded onto the second computing device at the first time, and the second sequence of data is associated with at least one of (1) hardware included in the second computing device at a second time or (2) software loaded onto the second computing device at a second time different from the first time.

13. The system of claim 11, where the first computing device is configured to determine if the first sequence of data and the second sequence of data are identical based at least in part on the outcomes of the one or more measurements.

14. The system of claim 10, where the first sequence of data comprises information associated with a first set of parameters associated with the second computing device.

15. The system of claim 10, where the using of the control circuitry to generate the first set of quantum states stored in the second plurality of quantum storage elements is based at least in part on the hypergraph-based representation associated with the first sequence of data and further comprises at least one of (1) assigning a value for each array element in an adjacency array representation based on at least one bit in the first sequence of data or (2) forming a hypergraph representation where each hyperedge between two or more nodes corresponds to at least one bit in the first sequence of data.

16. The system of claim 15, where the using of the control circuitry comprises assigning a value for each array element in the adjacency array representation based on at least one bit in the first sequence of data, and each array element indicates whether two or more nodes are adjacent or not in the hypergraph representation.

17. The system of claim 10, where the using of the control circuitry to generate the first set of quantum states stored in the second plurality of quantum storage elements is based at least in part on the hypergraph-based representation associated with the first sequence of data and further comprises applying controlled-Z quantum gate operations.

18. The system of claim 10, where the first sequence of data is associated with a configuration of the second computing device.

19. The system of claim 10, further comprising a third computing device comprising one or more processors in communication with (1) a second non-volatile memory, (2) a third plurality of quantum storage elements, and (3) control circuitry configured to apply quantum gate operations to the third plurality of the quantum storage elements.

20. The system of claim 19, further comprising a second quantum communication channel between the first computing device and the third computing device configured to transmit quantum states from the third computing device to the first computing device.
